(19) United States
(12) Patent Application Publication
(10) Pub. No.: US 2019/0325626 A1
(43) Pub. Date: Oct. 24, 2019

(54) GRAPHIC DESIGN SYSTEM FOR DYNAMIC CONTENT GENERATION

(71) Applicant: SAWA LABS, INC., Cincinnati, OH (US)

(72) Inventor: Francis Tao, Atlanta, GA (US)

(21) Appl. No.: 16/388,572

(22) Filed: Apr. 18, 2019

Related U.S. Application Data
(60) Provisional application No. 62/659,428, filed on Apr. 18, 2018.

(51) Int. Cl. G06T 11/60; G06T 11/00; G06F 3/0484; G06F 17/21

(52) U.S. Cl. CPC G06T 11/60; G06T 11/001; G06T 2200/24; G06F 17/214; G06F 17/212; G06F 3/04847

(57) ABSTRACT

This disclosure describes various aspects that involve dynamically generating content, such as brand-compliant content and/or creative content, for delivery via electronic communication channels or other communication channels. In some aspects, a brand engine provides a profile-development interface. The brand development engine builds a brand profile having constraints and stylization guidance based on inputs to the profile-development interface. In additional or alternative aspects, a design engine automatically generates or controls the modification of design content. For example, the design engine can receive input text and/or input graphics and dynamically generate design content by applying visual or text features to the input text and/or input graphics, subject to constraints obtained from the brand profile, and applying stylization operations indicated by the brand profile to the input text and/or input graphics.

### CROSS REFERENCE TO RELATED APPLICATIONS

This disclosure claims priority to U.S. Provisional Application No. 62/659,428, filed on Apr. 18, 2018, which is hereby incorporated in its entirety by this reference.

### TECHNICAL FIELD

This disclosure relates generally to computer-implemented methods and systems for computer graphics processing. More specifically, but not by way of limitation, this disclosure relates to graphic design system for dynamically generating content, such as brand-compliant content or other creative content, for delivery via electronic communication channels or other communication channels.

### BACKGROUND

Certain graphic design software tools are used to digitally implement content-creation operations that would be performed by hand. For instance, a graphic design software tool could include features for combining various graphics, text, and other content into digital design content, which can be customized for different communication channels (e.g., websites, mobile devices, etc.).

### SUMMARY

This disclosure describes various aspects that involve dynamically generating content, such as brand-compliant content and/or creative content, for delivery via electronic communication channels or other communication channels. In some aspects, a brand engine provides a profile-development interface. The brand development engine builds a brand profile having constraints and stylization guidance based on inputs to the profile-development interface. In additional or alternative aspects, a design engine automatically generates or controls the modification of design content. For example, the design engine can receive input text and/or input graphics and dynamically generate design content by applying visual or text features to the input text and/or input graphics, subject to constraints obtained from the brand profile, and applying stylization operations indicated by the brand profile to the input text and/or input graphics.

### BRIEF DESCRIPTION OF THE DRAWINGS

Features, aspects, and advantages of the present disclosure are better understood when the following Detailed Description is read with reference to the accompanying drawings. The patent or application file contains at least one drawing executed in color. Copies of this patent or patent application publication with color drawing(s) will be provided by the Office upon request and payment of the necessary fee.

FIG. 1 depicts an example of a digital graphic design system for dynamically generating content, according to certain aspects of the present disclosure.

FIG. 2 depicts an example of a computing system for implementing certain aspects of the present disclosure.

FIG. 3 depicts an example of a process for creating a brand profile usable for dynamic content creation, according to certain aspects of the present disclosure.

FIG. 4 depicts an example of a process for dynamically creating content using a brand profile, according to certain aspects of the present disclosure.

FIG. 5 depicts an example of a process for generating branded design content, according to certain aspects of the present disclosure.

FIG. 6 depicts an example of a process for producing and displaying provisional design content for review and selection, according to certain aspects of the present disclosure.

FIG. 7 depicts an example of a process for making one or more edits to one or more of received provisional branded design content, according to certain aspects of the present disclosure.

FIG. 8 depicts an example of a process for implementing one or more finalized designs as output branded design content, according to certain aspects of the present disclosure.

FIG. 9 depicts an example of a profile-development interface for configuring one or more color attributes of a brand profile, according to certain aspects of the present disclosure.

FIG. 10 depicts an example of a profile-development interface for configuring one or more color attributes that control, in a brand profile, how certain colors can be used, according to certain aspects of the present disclosure.

FIG. 11 depicts an example of a logo-configuration interface in a profile-development interface, according to certain aspects of the present disclosure.

FIG. 12 depicts an example of a profile-development interface for configuring one or more font attributes in a brand profile, according to certain aspects of the present disclosure.

FIG. 13 depicts an example of a profile-development interface for configuring one or more logo attributes in a brand profile, according to certain aspects of the present disclosure.

FIG. 14 depicts an example of a profile-development interface for configuring one or more logo attributes controlling how a logo can be cropped, according to certain aspects of the present disclosure.

FIG. 15 depicts an example of a profile-development interface for configuring one or more logo attributes controlling the type of backgrounds to which a logo can be applied, according to certain aspects of the present disclosure.

FIG. 16 depicts another example of a profile-development interface for configuring one or more logo attributes controlling the type of backgrounds to which a logo can be applied, according to certain aspects of the present disclosure.

FIG. 17 depicts an example of a profile-development interface for configuring one or more logo attributes controlling whether the branding engine can automatically generate a logo variant, according to certain aspects of the present disclosure.

FIG. 18 depicts an example of a profile-development interface for configuring one or more personality attributes, according to certain aspects of the present disclosure.

FIG. 19 depicts an example of a set of stylization options corresponding to different values for a particular personality dimension, according to certain aspects of the present disclosure.

FIG. 20 depicts an example of a set of stylization options corresponding to a combination of personality dimensions, according to certain aspects of the present disclosure.

FIG. 21 depicts an example of an example-based personality-refinement interface used for configuring one or more personality attributes of a brand profile, according to certain aspects of the present disclosure.

FIG. 22 depicts another example of an example-based personality-refinement interface used for configuring one or more personality attributes of a brand profile, according to certain aspects of the present disclosure.

FIG. 23 depicts an example of a set of wireframes that could be used in a content-creation, according to certain aspects of the present disclosure.

FIG. 24 depicts examples of content-filled wireframes that the design engine can generate in a content-creation process, according to certain aspects of the present disclosure.

FIG. 25 depicts examples of branded design content that is generated in a content-creation process by applying hard rules from the brand profile, according to certain aspects of the present disclosure.

FIG. 26 depicts examples of branded design content that is generated in a content-creation process by applying stylization guidance from the brand profile, according to certain aspects of the present disclosure.

FIG. 27 depicts examples of branded design content that are generated based on different brand volumes, according to certain aspects of the present disclosure.

FIG. 28 depicts an example of applying different stylization options to a block in a wireframe, according to certain aspects of the present disclosure.

FIG. 29 depicts examples of a data structure for storing brand attributes that could be included in a brand profile, according to certain aspects of the present disclosure.

### DETAILED DESCRIPTION

This involves dynamically generating brand-compliant content or other creative content for delivery via electronic communication channels or other communication channels. Certain aspects described herein can enhance the ability of computing devices to function as tools for automatically creating brand-compliant content or other creative content.

For instance, brand-compliant content can be generated based on constraints and/or permissions indicated by a brand profile. In a simplified, illustrative example, a brand profile can encompass various content attributes (e.g., imagery associated with a business, a business name, a color scheme associated with the business or certain products, etc.) that collectively form a brand, which can be valuable intellectual property for a business. Branding can indicate a reliability, functionality, or other feature of a given device, process, or other product or service. Thus, when generating design content, graphic design software tools are often used to ensure that the design content that is compliant with a brand. But conventional techniques, which omit one or more aspects described herein, often involve manual review and modification of design content to ensure brand compliance (e.g., reviewing a brand book, comparing a generated design to various attributes described in the brand book, and removing or modifying design elements that deviate from the attributes described in the brand book). This is a significant source of needless communication and reproduction of work for both parties, and a potential source of error due to miscommunication or hurried action in light of a deadline.

A digital design application is used to dynamically generate brand-compliant design content. For instance, the digital design application provides, to a user device, a content-creation interface having control elements for identifying one or more input graphics and one or more input text elements to be included in the design content (e.g., a text field for receiving typing input that includes text, an upload tool or element for causing graphics or other content to be transmitted from a user device to a digital graphic design computing system, etc.). The digital design application uses the input graphics and input text obtained via the content-creation interface to automatically generate design content that is compliant with a brand.

To do so, the digital design application can access a brand profile repository, which could be a database or other suitable data structure for storing brand profiles. A brand profile can be a data structure having a set of brand attributes with attribute values that, in combination, control the automatic generation of design content. For instance, brand attributes in a brand profile could include permissible text features (e.g., constraints on fonts and font attributes to be used in the design), permissible visual features for displaying the input graphic (e.g., color schemes to be used, restrictions on overlaying certain colors over the input graphic, etc.), and other elements to be displayed with the input graphic and text (e.g., constraints or permissions with respect to a logo graphic). In some aspects, the brand profile can be created, at least in part, based on an automated analysis of brand exemplars.

The digital design application generates output branded design content based on a combination of the permissible text features of the input text, the permissible visual features of the input graphic, and the identified additional elements. For instance, the digital design application generates a content layout that includes the input text, the input graphic, and additional content in a manner that does not violate any constraint identified in the retrieved brand profile. The digital design application can arrange the input text, the input graphic, and additional content within the layout in a manner consistent with a personality attribute in the brand profile (e.g., stylistic guidance on the variety of content, the spacing between content items, etc.). The digital design application can present the output branded design content via the content-creation interface for further editing or export by a user device. In some aspects, if the user device receives edits to the output branded design content, the digital design application can assess these edits for compliance with the brand profile, and reject edits that fail to comply with the brand profile (e.g., by ignoring the edit rather than modifying the output branded design content in a non-compliant manner).

As described herein, certain aspects provide improvements in graphics processing by automatically applying various rules of a particular type, such as constraints and/or permission with respect to available content attributes, to control the manner in which computing devices dynamically create visual design content for transmission via one or more communication channels. For example, these embodiments automatically compute various configuration parameters of an electronic design. Examples of these configuration parameters could include a layout of the design, a number of layers, color combinations, position and appearance of text, and other parameters that control how design content is created for display. Furthermore, using constraints and/or permissions from a particular content profile (e.g., a brand profile) to guide the computation of these parameters allows for the dynamic generation of design content with a greater degree of automation than provided by conventional solutions. This process reduces or eliminates the need to rely on user inputs (e.g., drawing inputs, template edits, etc.) to manually modify various configuration parameters of electronic design content.

The automated application of these rules are facilitated by and specifically improve digital graphic editing. By contrast, conventional techniques for generating brand-compliant content or other creative content require subjective determinations applied to imprecise manual operations, such as manually checking for prohibited or undesirable color schemes, manually adjusting layout or content combinations to maintain consistency with a desired brand personality, manually omitting or removing improper color or font attributes from design content, etc. Thus, embodiments described herein improve computer-implemented processes that are unique to generating branded digital content, thereby providing a more suitable solution for automating tasks previously performed by humans.

Furthermore, certain embodiments provide improvements to computing systems used for creating digital design content by, for example, reducing cumbersome or time-consuming processes for ensuring that content attributes (e.g., layout, overlays, color schemes, etc.) comply with a brand profile. These problems can be addressed by various user interface features described herein. For instance, a brand-development interface, a content-creation interface, or both can include control elements with functionalities that facilitate the automation of a brand profile's development, the application of a brand profile to content creation, or some combination thereof. Thus, the structure and associated functionality of the interface features described herein can provide improvements in the field of digital graphic design.

Example of Digital Graphic Design System for Dynamically Generating Content

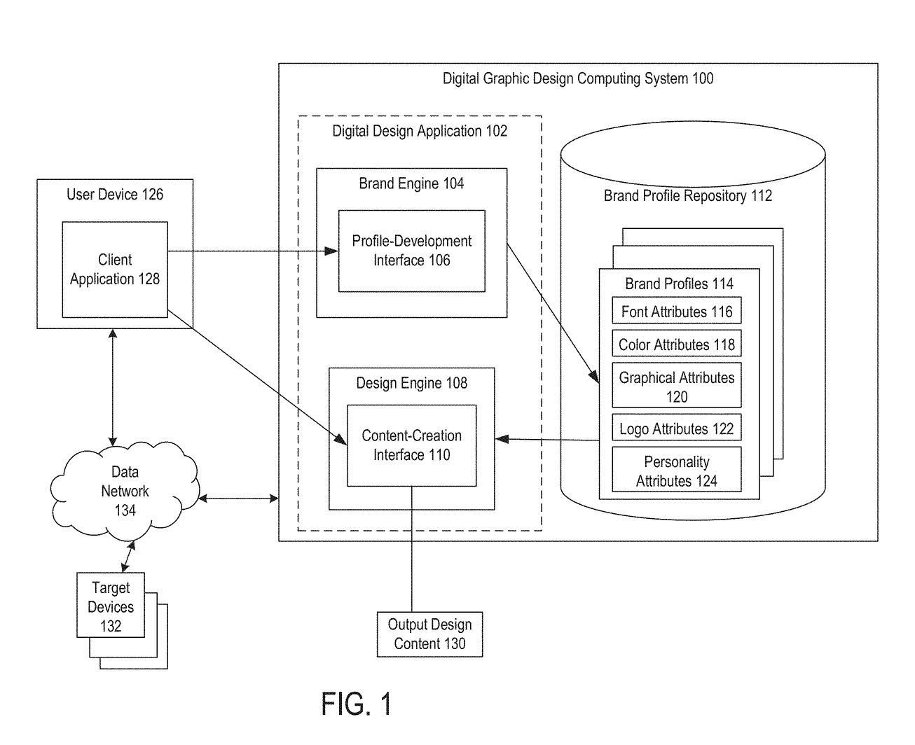

Referring now to the drawings, FIG. 1 depicts an example of a digital graphic design computing system 100. In this example, the digital graphic design computing system 100 is communicatively coupled to one or more user devices 126 via one or more data networks 134. In some aspects, the digital graphic design computing system 100, the user device 126, or both can be communicatively coupled to one or more target devices 132 via one or more data networks 134.

The digital graphic design computing system 100 includes one or more computing devices (e.g., a dedicated server, a set of servers in a distributed computing configuration, an end-user computing device, etc.). The digital graphic design computing system 100 may be a computing device such as a physical, virtual, or cloud server having capabilities such as receiving, storing, and manipulating data, and communicating over a network.

The digital graphic design computing system 100 includes processing hardware that can execute a digital design application 102. The digital design application 102 includes program instructions that, when executed, can provide a variety of interfaces, features, and functions to users via a user device 126. For example, the digital design application 102 can include a brand engine 104 and a design engine 108. Each of the brand engine 104 and the design engine 108 includes program instructions for displaying and editing design content, such as text, images or other graphics, videos, or some combination thereof. Examples of these program instructions include program instructions for rendering content for display, program instructions for creating one or more instances of event listeners or other suitable objects for receiving input from input devices (e.g., a mouse, a touchscreen, etc.), program instructions for overlaying different graphics in a multilayer design, program instructions for automatically generating HTML code, program instructions for formatting content in different file formats (e.g., JPG, PDF, etc.).

For instance, the brand engine 104 can generate, update, provide, and/or communicate via one or more profile-development interfaces 106. The brand engine 104 can update data stored in a brand profile repository 112 based on inputs received via a profile-development interface 106. The brand engine 104 can also retrieve data stored in a brand profile repository for display via a profile-development interface 106.

Additionally or alternatively, the design engine 108 can generate, update, provide, and/or communicate via one or more content-creation interfaces 110. The design engine 108 can generate, edit, or otherwise assist in the creation of output branded design content 130. To do so, the design engine 108 can retrieve data stored in a brand profile repository 112, such as a brand profile 114 and various brand attributes therein. The design engine 108 can use the retrieved data, in combination with input received via one or more content-creation interfaces, to guide the creation of the output branded design content 130.

A user device 126 may be, for example, a computer, laptop, mobile, tablet, or other computing device having features such as a display, a user interface, and a network device capable of communicating with the digital graphic design computing system 100. The user device 126 can execute a client application 128 (e.g., a browser, a dedicated design application, etc.) that is configured to establish a communication session with the digital design application 102 and thereby access features of the digital design application 102 via one or more profile-development interfaces 106, one or more content-creation interfaces 110, or some combination thereof. At a high level, the digital graphic design computing system 100 is capable of producing various output branded design content 130 based upon a small set of inputs from the user device 126. In this manner, a user of the user device 126 may manage and produce different graphic designs (i.e., different sets of output branded design content 130) suitable for different purposes at a greatly reduced cost in time and other resources as compared to working with a professional graphic designer or other design consultant.

Another example of a user device 126 is an imaging device, such as a camera, scanner, or other image capture device. Such an imaging device is capable of capturing images of graphic designs in the real world and providing that output to the digital graphic design computing system 100. Such images could be analyzed by the digital graphic design computing system 100 to automatically determine one or more characteristics about a brand associated with the captured images.

In some implementations, the digital graphic design computing system 100, one or more user devices 126, or some combination thereof may be in communication with various other target devices 132 that provide additional features and functionality to an end user. One example of a target device 132 is a local or remote printer that is able to produce physical flyers, posters, mailers, and other print products based upon input from the digital graphic design computing system 100. Another example of a target device 132 is an advertising or other content-providing server that can be configured to serve graphic designs to various websites, mailing lists, billboards, or other advertisement mediums. Such a server could automatically serve recently produced graphic designs that are received from the digital graphic design computing system 100. Another example of a target device 132 is a computing system that hosts or otherwise provides access to one or more social sites or social media outlets via one or more accounts on those outlets, where graphic designs generated with the digital graphic design computing system 100 may be viewed by members and visitors to those sites.

The brand engine 104 can provide one or more profile-development interfaces 106 to a user device 126. A profile-development interface 106 can prompt an end user to input, select, or otherwise identify various brand attribute values that are used to develop a brand profile 114. A brand attribute can specify one or more constraints on visual characteristics of output branded design content 130 generated by the design engine 108. In some aspects, a constraint that is specified by or otherwise indicated by a brand attribute indicates which visual characteristics are required for the output branded design content 130 (e.g., a set of colors that should always be included somewhere in the output branded design content 130). In additional or alternative aspects, a constraint that is specified by or otherwise indicated by a brand attribute indicates which visual characteristics are prohibited for the output branded design content 130 (e.g., a set of colors that should never be included anywhere in the output branded design content 130).

One example of a brand attribute is a font attribute 116. For instance, font attributes 116 could include a font type, a font size, a font style, a capitalization setting, a color of text, a priority for the font, etc. For instance, the brand engine 104 could use inputs received via a profile-development interface 106 to identify a particular font type (e.g., Times New Roman) as a having a “primary” priority and to identify a second font type (e.g., Arial) as a having a “secondary.” A font attribute 116 could identify a font as being allowed or prohibited. For instance, primary and secondary fonts would be “allowed” fonts, whereas a prohibited font type (e.g., Comic Sans) could be added to a “prohibited” list (e.g., because the font is used by a competitor). Similar permissions or prohibitions could also be applied to other types of font attributes 116 (e.g., prohibitions on capitalizing all letters of a word, requirements to use only bold or underlined text, etc.).

Another example of a brand attribute is a color attribute 118. For instance, color attributes 118 could include permissions or prohibitions on background colors, permissions or prohibitions on color combinations, priority for a color, etc. In a simplified example, a color attribute 118 could be used to specify that only a set of two colors, such as green and orange, is to be added to user-provided content in order to generate output branded design content 130. In this simplified example, the color attribute 118 could constrain the design engine 108 by only permitting the design engine 108 to place input graphical content (e.g., a digital image uploaded by the user device 126) on a green or orange background. In another example, a color attribute 118 could indicate a priority for a color. For instance, a priority color attribute 118 could identify “orange” as a “primary” color that should be used in a larger proportion of the output branded design content 130, and could identify “green” color as a color that should be used in a smaller proportion of the output branded design content 130.

In some aspects, a color attribute could be used to identify one or more primary colors associated with a brand profile, one or more secondary colors associated with the brand profile, and one or more color restrictions associated with the brand profile. For example, one brand may have blue as a primary color associated with red as a secondary color, as well as blue as a primary color associated with white as a secondary color. The same brand may have a competitor that uses blue as a primary color associated with yellow as a secondary color, so yellow might be entirely restricted, or might be restricted from use with blue.

Another example of a brand attribute is a logo attribute 122. A logo attribute 122 could include a logo design (e.g., a graphic, text, or some combination thereof), permissions or prohibitions on visual characteristics for a logo design (e.g., permitted or prohibited placement within a layout, maximum or minimum absolute size, maximum or minimum relative size with respect to other graphical elements in a layout, etc.), etc. Brand logos may include trademarks or other textual and visual designs that a brand may use to identify itself and to provide an indication of a source of a product or service.

In some aspects, the brand engine 104 can automatically determine options for visual characteristics, such as automatically generating color variants with respect to a logo design (e.g., creating a black-and-white version of an uploaded image of a logo). In some aspects, the brand engine 104 can display, via a profile-development interface 106, one or more control elements that solicit input for rejecting or accepting automatically generated options (e.g., displaying a preview of a color variant next to a checkbox, where a selection of the checkbox indicates that the color variant should be included in the brand profile).

Another example of a brand attribute is a graphical attribute 120. Graphical attributes 120 may indicate permissions or prohibitions on graphics to be included in the output branded design content 130. For instance, a graphical attribute 120 could identify a brand photograph. Examples of brand photographs could include images associated with the brand that are not logos, such as images of a company's headquarters, a company's executives, a company's products, etc.

In some aspects, a graphical attribute 120 could indicate a requirement, permission, or prohibition on input graphical content that is selected with a user device 126 in a content creation process for automatically generating output branded design content 130. In one example, a graphical attribute 120 could indicate that only images from certain online sources may be used. If the design engine 108 receives a user input specifying a certain website as the source of an image, and that website is not included in a set of permissible online sources, the design engine 108 could prevent the image from being included in the output branded design content 130 (e.g., by ignoring the image in the content-creation process); otherwise, the design engine 108 could include the image in the output branded design content 130. In another example, the graphical attribute 120 could indicate that certain graphical characteristics must be included in the input graphical content that is selected with a user device 126. As a simplified example, the graphical attribute 120 could indicate that the input graphical content must include a certain type of object (e.g., a car). If the design engine 108 receives a user input specifying a particular image as the input graphical content, the design engine 108 can apply a classifier (e.g., a machine learning algorithm trained to recognize cars) to the particular image. If the classifier does not classify any object in the image as a car, the design engine 108 could prevent the image from being included in the output branded design content 130 (e.g., by ignoring the image in the content-creation process); otherwise, the design engine 108 could include the image in the output branded design content 130.

Another example of a brand attribute is a personality attribute 124. One or more personality attributes 124 can specify or indicate a set of visual characteristics that provide soft or fuzzy guidance to the design engine 108. The guidance is soft or fuzzy in that, for instance, other specified attributes (e.g., font attributes, color attributes, etc.) will override the personality attribute 124. In one example, if a personality attribute 124 has a value of “modern,” the design engine 108 may partition a design canvas into a larger number of smaller sections and with a variety of colors and images. In this example, if the color attribute specifies six permissible colors, the design engine 108 could use all six colors to generate output branded design content 130 having a “modern” style. In another example, if a personality attribute 124 has a value of “traditional,” the design engine 108 may partition a design canvas into a smaller number of larger sections with a limited number of colors and images (e.g., two colors and one image). In this example, if the color attribute specifies six permissible colors, the design engine 108 could use only two of the six colors in any particular branded design content 130 to ensure that the output branded design content 130 has a “traditional” style.

A personality attribute 124 could indicate, for example, whether output branded design content 130 generated based on the brand profile 114 should include a combination of visual characteristics (e.g., text characteristics, color characteristics, and layout characteristics) indicating that the brand is more modern than traditional (e.g., use of certain colors or shapes that suggest modern design), more funny than serious (e.g., use of certain font styles that suggest humor or a relaxed nature), more intellectual than physical (e.g., balance of text versus images in brand examples), etc.

In additional or alternative aspects, the brand engine 104 can identify values of various brand attributes based on, at least in part, an automated analysis of one or more brand exemplars. For instance, the brand engine 104 could cause the user device 126 to present a profile-development interface 106 for uploading a brand exemplar. Examples of a brand exemplar could include an electronic version of a brand book in any of a variety of formats, digital images of graphic designs, products, or business locations associated with the brand, or web search results associated with the brand. The brand engine 104 could extract, from the brand exemplar, one or more brand attributes values. For example, the brand engine 104 could perform a visual analysis of one or more brand exemplars to identify one or more colors associated with the brand, text styles associated with the brand, or logos and digital imagers associated with the brand. An automated analysis could include identifying, for a given brand attribute, different values of the brand attribute found within the brand exemplar and presenting some or all of the identified values in a profile-development interface 106 for selection, exclusion, and/or modification via further inputs received via the user device 126.

In one example, the brand engine 104 can identify different font attribute values. For instance, the brand engine 104 can identify text included within the brand exemplar. (In some aspects, the brand engine 104 can detect images depicting text and perform an optical character recognition process to identify the depicted text.) The brand engine 104 can classify identified text as having a certain typeface. For example, the brand engine 104 can execute a machine learning algorithm that is trained or otherwise configured to match certain visual attributes of text glyphs (e.g., width of stems or bowls, curvature, etc.) to certain a particular typeface (e.g., Arial, Courier, Times New Roman, etc.). For the text portions of a particular typeface, the brand engine 104 can identify instances of different font attributes, such as size (e.g., 10 point, 12 point, etc.), style (bold, italic, etc.), and color. The brand engine 104 can cause the user device 126 to display a profile-development interface 106 that includes some or all of the identified font attributes. For instance, the profile-development interface 106 could present a list of detected typefaces, a list of font sizes, a list of font colors, and a list of font styles. In some cases, the profile-development interface 106 could present the font attributes and values based on the detected combinations. For instance, the profile-development interface 106 could present a list of typefaces with associated font attributes of those typefaces as detected in the brand exemplar (e.g., “Courier: 10 pt, 12 pt, 14 pt; bold, italics,” “Times New Roman: 8 pt, 12 pt, 14 pt; bold”). The brand engine 104 can receive, from the user device 126, inputs to the profile-development interface 106 that confirm certain font attributes identified from the brand exemplar as being part of the brand profile, that exclude certain font attributes identified from the brand exemplar from being part of the brand profile (e.g., removing “Courier” or removing “14 pt” font sizes), and/or that add certain font attributes to the list identified from the brand exemplar (e.g., adding “16 pt” font size to a list of “10 pt, 12 pt, 14 pt”).

In some aspects, the brand engine 104 can limit the font attribute values presented in a profile-development interface 106. For instance, the brand engine 104 can select, for the profile-development interface 106, font attribute values meeting some frequency-of-use criterion and exclude, from the profile-development interface 106, font attribute values that fail to meet the frequency-of-use criterion. In one example, the brand engine 104 can rank font attribute values based on how frequently they occur in the text (e.g., “12 pt, 8 pt, 20 pt” if 70% of the text includes 12-point font, 20% of the text includes 8-point font, and 10% of the text includes 20-point font). The brand engine 104 can select k font attribute values based on their rank. For instance, the most common font attribute values (e.g., the three highest ranked font sizes) may indicate that sizes that are more appropriate due to being used most frequently, or the least common font attribute values (e.g., the three lowest ranked font sizes) may indicate that they are more appropriate because they are more distinctive as compared to the rest of the detected text. Additionally or alternatively, the brand engine 104 can select font attribute values based on a threshold frequency (e.g., font sizes that occur in more than 60% of the detected text, font sizes that occur in less than 10% of the detected text, etc.).

In another example, the brand engine 104 can identify different color attribute values. For instance, the brand engine 104 can identify colors included within the brand exemplar (e.g., different sets of RGB values). The brand engine 104 can cause the user device 126 to display a profile-development interface 106 that includes some or all of the identified color attributes. For instance, the profile-development interface 106 could present a list of detected colors, a palette that only includes the detected colors, etc. In some aspects, the brand engine 104 can limit the color attribute values presented in a profile-development interface 106. For instance, the brand engine 104 can select, for the profile-development interface 106, color attribute values meeting some frequency-of-use criterion and exclude, from the profile-development interface 106, color attribute values that fail to meet the frequency-of-use criterion. In one example, the brand engine 104 can rank color attribute values based on how frequently they occur in the brand exemplar. The brand engine 104 can select k color attribute values based on their rank. Additionally or alternatively, the brand engine 104 can select color attribute values based on a threshold frequency (e.g., colors that occur in more than 60% of the content within the brand exemplar, colors that occur in less than 30% of the content within the brand exemplar).

In some aspects, the brand engine 104 can present detected colors in the profile-development interface 106 along with one or more indicators of how frequently the detected colors are used. In one example, a list of colors can be ordered according to how frequently each color occurs in content within the brand exemplar. In another example, a color palette can include different color indicators (e.g., a set of colored circles representing the different colors) having visual characteristics representing how frequently each color occurs in content within the brand exemplar (e.g., a first circle representing a first color being larger than a second circle representing a second color based on the first color occurring more frequently than the second color).

In another example, the brand engine 104 can identify different graphical attribute values. For instance, the brand engine 104 can identify images or other graphics included within the brand exemplar (e.g., different non-textual objects depicted in the brand exemplar). For instance, the profile-development interface 106 could present a list of detected graphics, a set of tiles with thumbnails representing respective graphics detected in the brand exemplar, etc.

In some aspects, the brand engine 104 can limit the graphical attribute values presented in a profile-development interface 106. For instance, the brand engine 104 can classify certain graphics based on their semantic content (e.g., which objects or object types are depicted), their stylistic content (e.g., certain color schemes), or some other visual characteristic or combination of visual characteristics.

In some aspects, the brand engine 104 can select, for the profile-development interface 106, graphics based on some classification criterion and exclude, from the profile-development interface 106, graphical attribute values that fail to meet the classification criterion. For instance, the brand engine 104 can select only graphics that can be classified into one or more classes and exclude graphics that cannot be classified. In one example, the brand engine 104 may be configured to only present, in a profile-development interface 106, graphics depicting objects within certain user-selected classes (e.g., logo objects, certain products, certain individuals, certain color schemes, etc.).

In additional or alternative aspects, the brand engine 104 can select, for the profile-development interface 106, graphics some frequency-of-use criterion and exclude, from the profile-development interface 106, graphical attribute values that fail to meet the frequency-of-use criterion. In one example, the brand engine 104 can rank classes of graphics based on how frequently they occur in the brand exemplar. The brand engine 104 can select k classes of graphics based on their rank. Additionally or alternatively, the brand engine 104 can select classes of graphical attribute values based on a threshold frequency.

Brand attributes, brand exemplars or both can be obtained in any suitable manner. For instance, a brand book publisher may be a local process or separate system that is capable of receiving input from the digital graphic design computing system 100 and producing industry standard data sets describing the characteristics and constraints of a certain brand. This type of industry standard output could include brand books in a variety of standard computer formats, proprietary data sets that could be shared between users of the digital graphic design computing system 100 to quickly transport brand data, and other similar outputs.

In various aspects, the digital graphic design computing system 100 can be used to dynamically generate different types of content. In one example, the digital graphic design computing system 100 can be used to generate brand-compliant content. Brand-compliant content can include a combination of graphical content and text that does not violate any constraint indicated by a brand profile, that uses permissible visual or textual features indicated by a brand profile, or some combination thereof. In another example, the digital graphic design computing system 100 can be used to generate creative content. Creative content can include a combination of graphical content and text that has been stylized or otherwise modified after being uploaded, selected, or otherwise identified via user inputs (e.g., inputs from a user device 126). In some aspects, creative content can be content that is stylized or otherwise modified in accordance with one or more personality attributes. Certain content can be both brand-compliant and creative, in that stylizations or modifications to imagery, text, or both are guided by one or more personality attributes subject to constraints indicated by other attributes in a brand profile (e.g., font attributes, color attributes, logo attributes, graphical attributes, etc.).

Example of a Computing System for Implementing Certain Aspects

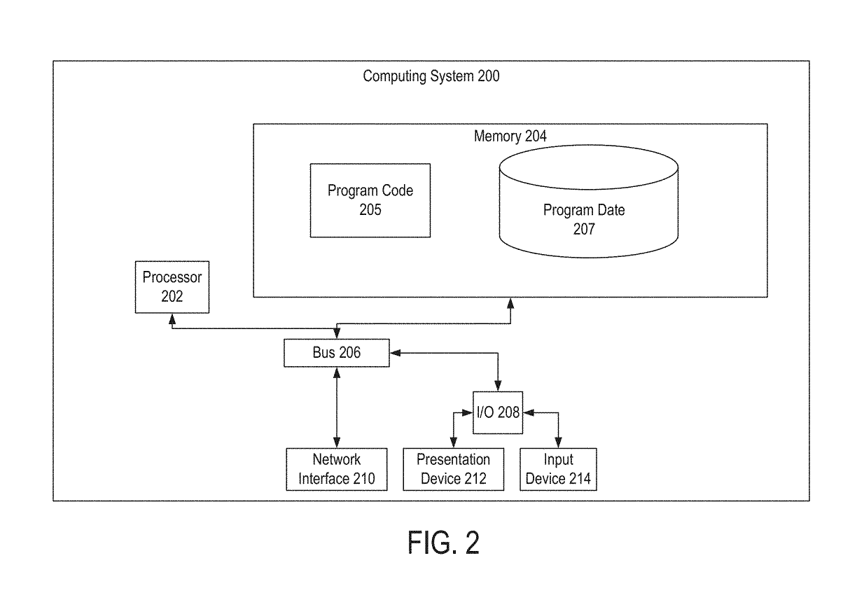

Any suitable computing system or group of computing systems can be used for performing the operations described herein. For example, FIG. 2 depicts an example of a computing system 200. One or more devices depicted in FIG. 1 (e.g., a digital graphic design computing system 100, a user device 126, a target device 132) can be implemented using the computing system 200 or a suitable variation.

The computing system 200 can include processing hardware 202 that executes program instructions 205 (e.g., the digital design application 102, one or more engines such as the brand engine 104 and/or the design engine 108, a client application 128, a browser or other end-user application on a target device, etc.). The computing system 200 can also include a memory device 204 that stores one or more sets of program data 207 computed or used by operations in the program instructions 205 (e.g., a brand profile repository, text or graphics uploaded by an end user, etc.). The computing system 200 can also include and one or more presentation devices 212 and one or more input devices 214. For illustrative purposes, FIG. 2 depicts a single computing system on which the program instructions 205 is executed, the program data 207 is stored, and the input devices 214 and presentation device 212 are present. But various applications, datasets, and devices described can be stored or included across different computing systems having devices similar to those depicted in FIG. 2.

The depicted example of a computing system 200 includes processing hardware 202 communicatively coupled to one or more memory devices 204. The processing hardware 202 executes computer-executable program instructions stored in a memory device 204, accesses information stored in the memory device 204, or both. Examples of the processing hardware 202 include a microprocessor, an application-specific integrated circuit (“ASIC”), a field-programmable gate array (“FPGA”), or any other suitable processing device. The processing hardware 202 can include any number of processing devices, including a single processing device.

The memory device 204 includes any suitable non-transitory computer-readable medium for storing data, program instructions, or both. A computer-readable medium can include any electronic, optical, magnetic, or other storage device capable of providing a processor with computer-readable instructions or other program instructions 205. Non-limiting examples of a computer-readable medium include a magnetic disk, a memory chip, a ROM, a RAM, an ASIC, optical storage, magnetic tape or other magnetic storage, or any other medium from which a processing device can read instructions. The program instructions 205 may include processor-specific instructions generated by a compiler or an interpreter from code written in any suitable computer-programming language, including, for example, C, C++, C#, Visual Basic, Java, Python, Perl, JavaScript, and ActionScript.

The computing system 200 may also include a number of external or internal devices, such as an input device 214, a presentation device 212, or other input or output devices. For example, the computing system 200 is shown with one or more input/output (“I/O”) interfaces 208. An I/O interface 208 can receive input from input devices or provide output to output devices. One or more buses 206 are also included in the computing system 200. The bus 206 communicatively couples one or more components of a respective one of the computing system 200.

The computing system 200 executes program instructions 205 that configures the processing hardware 202 to perform one or more of the operations described herein. The program instructions 205 includes, for example, the digital design application 102, the brand engine 104, the design engine 108, or other suitable program instructions that perform one or more operations described herein. The program instructions 205 may be resident in the memory device 204 or any suitable computer-readable medium and may be executed by the processing hardware 202 or any other suitable processor. The program instructions 205 uses or generates program data 207.

In some aspects, the computing system 200 also includes a network interface device 210. The network interface device 210 includes any device or group of devices suitable for establishing a wired or wireless data connection to one or more data networks. Non-limiting examples of the network interface device 210 include an Ethernet network adapter, a modem, and/or the like. The computing system 200 is able to communicate with one or more other computing devices via a data network using the network interface device 210.

A presentation device 212 can include any device or group of devices suitable for providing visual, auditory, or other suitable sensory output. Non-limiting examples of the presentation device 212 include a touchscreen, a monitor, a separate mobile computing device, etc. An input device 214 can include any device or group of devices suitable for receiving visual, auditory, or other suitable input that controls or affects the operations of the processing hardware 202. Non-limiting examples of the input device 214 include a recording device, a touchscreen, a mouse, a keyboard, a microphone, a video camera, a separate mobile computing device, etc.

Although FIG. 2 depicts the input device 214 and the presentation device 212 as being local to the computing device that executes the program instructions 205, other implementations are possible. For instance, in some aspects, one or more of the input devices 214 and the presentation device 212 can include a remote client-computing device that communicates with the computing system 200 via the network interface device 210 using one or more data networks described herein.

Example of Profile-Development Process

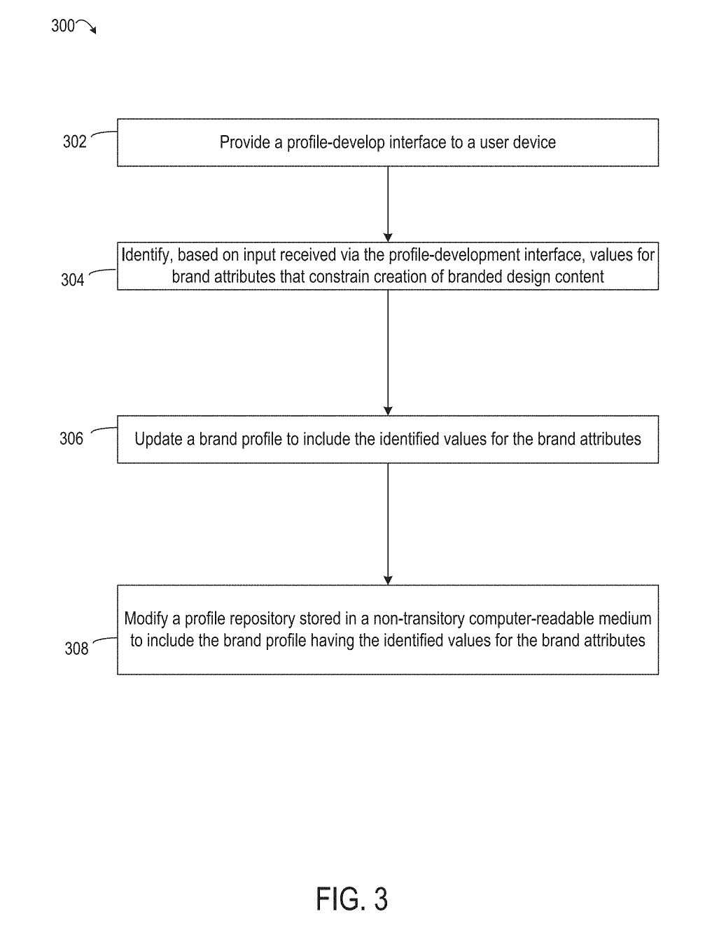

FIG. 3 depicts a process 300 in which the brand engine 104 is used to create a brand profile. In some aspects, one or more computing devices, such as a digital graphic design computing system 100 and/or a user device 126, implement operations depicted in FIG. 3 by executing suitable program instructions (e.g., the client application 128, one or more of the engines depicted in FIG. 1, etc.). For illustrative purposes, the process 300 is described with reference to certain examples depicted in the figures. Other implementations, however, are possible.

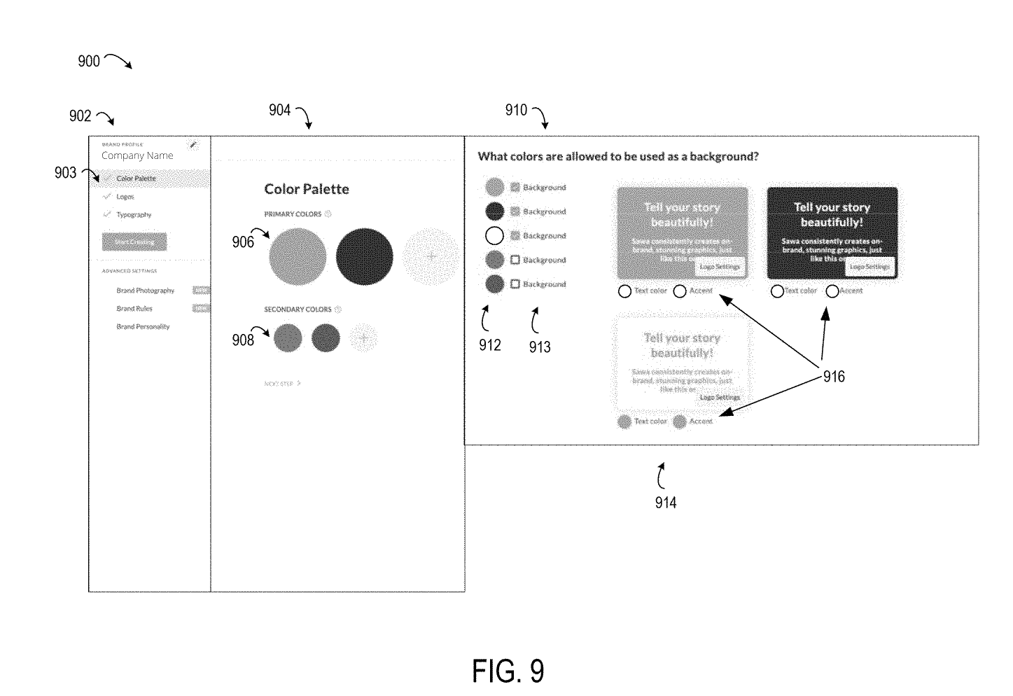

At block 302, the process 300 involves providing a profile-development interface 106 to a user device 126. For instance, the brand engine 104 can cause an instance of the profile-development interface 106 to be displayed on the user device 126. The profile-development interface 106 can include one or more control elements for selecting, verifying, or otherwise identifying various attribute values. Examples of different profile-development interfaces are described herein with respect to FIGS. 9-18, 21, and 22.

At block 304, the process 300 involves identifying, based on input received via the profile-development interface, values for brand attributes that constrain creation of branded design content. Examples of the brand attributes could include one or more font attributes 116 indicating permissible text features for displaying text in branded design content, one or more color attributes 118 indicating permissible colors for inclusion in the branded design content, one or more graphical attributes 120 indicating permissible graphical content for inclusion in the branded design content, one or more logo attributes 122 indicating permissible logo variant for inclusion in the branded design content, and/or one or more personality attributes indicating stylization options for the branded design content.

In some aspects, the brand engine 104 can use electronic data of one or more brand exemplars to identify one or more brand attribute values. For instance, as described above with respect to FIG. 1, the brand engine 104 can identify, from input received via the profile-development interface 106, a brand exemplar having a design content example. The design content example could include one or more text examples, one or more graphic examples, or both. The brand engine 104 can perform an analysis of the brand exemplar. The analysis could identify various attribute value sets, such as, for example, a set of font values for the font attribute included within the brand exemplar, a set of color values for the color attribute included within the brand exemplar, a set of graphics included within the brand exemplar, etc. The brand engine 104 can update the profile-development interface 106 to include one or more control elements configured for receiving input selecting at least some of the identified attribute values.

In one example, the profile-development interface 106 could be configured for receiving a font-selection input that selects at least some font values from the set of font values. In another example, the profile-development interface 106 could also be configured for receiving a color-selection input selecting at least some color values from a set of color values identified via an analysis of a brand exemplar. For instance, one or more font value indicators could indicate all font values in the set of font values (e.g., a list of all font values, a range of font values indicated by the maximum and minimum font values), one or more color value indicators indicating all color values in the set of color values (e.g., a different visualization for each color, a set of RGB values for each color), etc. The brand engine 104 can respond to a selection of one or more font attribute values by modifying a corresponding brand attribute (e.g., the font attribute, the color attribute, etc.) to include selected attribute values (e.g., font values indicated by a font-selection input, color values indicated by a color-selection input, etc.).

In some aspects, the brand engine 104 can determine an attribute value (e.g., a font value, a color value, etc.) has a frequency of occurrence within a brand exemplar that is less than a threshold frequency (e.g., a frequency lower than a specified threshold). The brand engine 104 can exclude, from a set of attribute values displayed in the profile-development interface, one or more attribute values having a frequency of occurrence within the brand exemplar that is less than the threshold frequency.

At block 306, the process 300 involves updating a brand profile to include the identified values for the brand attributes. For example, the brand engine 104 can access one or more records or other data structures representing the brand attributes. The brand engine 104 can update one or more fields in the accessed record to include attribute values specified by input to the profile-development interface 106, attribute values derived from input to the profile-development interface 106, attribute values selected via input to the profile-development interface 106, etc.

At block 308, the process 300 involves modifying a profile repository stored in a non-transitory computer-readable medium to include the brand profile having the identified values for the brand attributes. For example, the brand engine 104 can access a brand profile repository 112 stored on a non-transitory computer-readable medium of the digital graphic design computing system 100. The brand engine 104 can update the brand profile repository 112 to include the updated brand profile. The brand engine 104 can control a process for creating the branded design content by restricting permissible modifications to the branded design content that may be implemented via a content-creation interface provided to the user device.

Examples of Content-Creation Processes

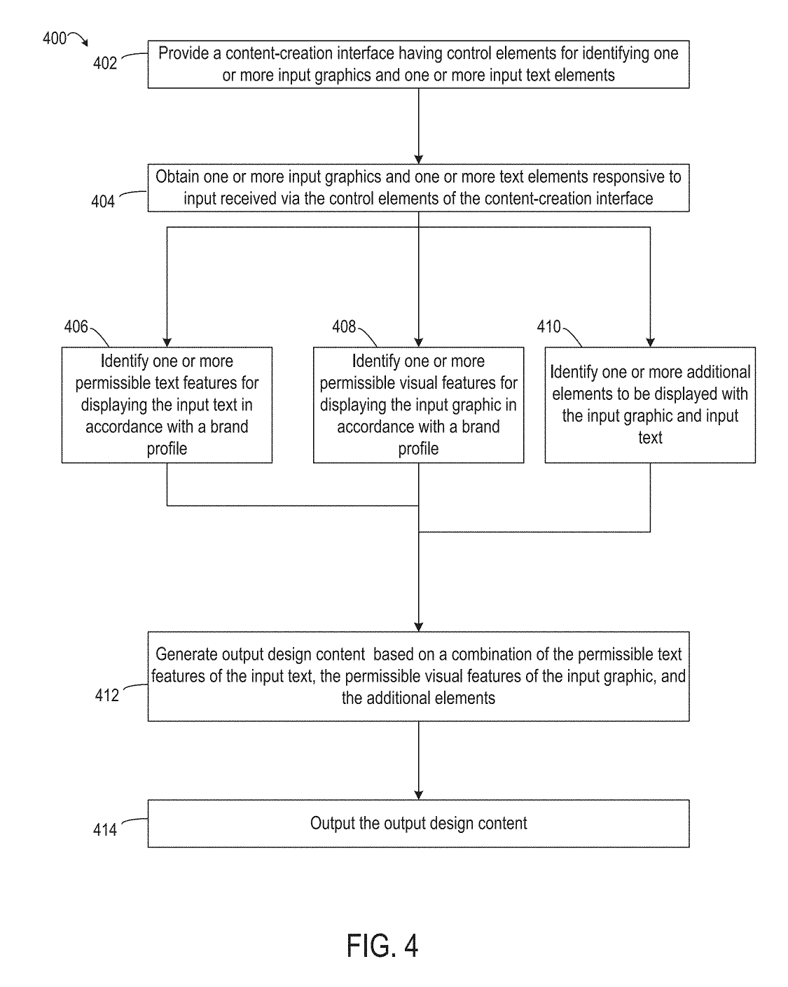

FIG. 4 depicts a process 400 in which the design engine 108 can use a combination of inputs from the user device 126 and a brand profile 114 to generate the output branded design content 130. In some aspects, one or more computing devices, such as a digital graphic design computing system 100 and/or a user device 126, implement operations depicted in FIG. 4 by executing suitable program instructions (e.g., the client application 128, one or more of the engines depicted in FIG. 1, etc.). For illustrative purposes, the process 400 is described with reference to certain examples depicted in the figures. Other implementations, however, are possible.

The process 400 involves providing a content-creation interface having control elements for identifying one or more input graphics and one or more input text elements, as depicted at block 402. For instance, the design engine 108 can cause an instance of the content-creation interface 110 to be displayed on the user device 126. In one example, the content-creation interface 110 includes a graphic-selection control element and a text input element. The graphic-selection control element could include a field for specifying a location of an input graphic, such as a directory on the user device 126 from which an image is to be uploaded or a network address of an online image source (e.g., a website with publicly accessible images) from which an image is to be retrieved. The graphic-selection control element could include a text field in which typing input specifying text could be typed, an upload tool or element having a field for specifying a location of an input text file (e.g., a directory on the user device 126), or some combination thereof.

The process 400 also involves obtaining one or more input graphics and one or more text elements responsive to input received via the control elements of the content-creation interface, as depicted at block 404. The design engine 108 can cause the digital graphic design computing system 100 to implement block 404 by retrieving, receiving, or otherwise obtaining one or more input graphics and one or more text elements from the user device 126, a remote computing system, a memory device of the digital graphic design computing system 100, or some combination thereof.

In one example, the digital graphic design computing system 100 can obtain an input graphic by receiving the input graphic, via a communication session between the digital graphic design computing system 100 and the user device 126. In this example, the user device 126 retrieves the input graphic from a memory location of the user device 126, where the memory location is indicated by the input to the content-creation interface 110, and transmits the input graphic to the digital graphic design computing system 100 via one or more data networks. For instance, the user device 126 could be used to upload an input graphic using an upload element configured for (i) receiving a text input identifying a memory location in which a file containing the input text element is stored and (ii) instructing the one or more processing devices to retrieve the file from the memory location, or could be used to upload the input graphic using a drag-and-drop field configuring for receiving a drag-and-drop input moving a visual representation of the input graphic over the content-creation interface, wherein the one or more processing devices retrieve the input graphic responsive to receiving the drag-and-drop input. In another example, the digital graphic design computing system 100 can obtain an input graphic by identifying, from input to the content-creation interface 110, a network address of an online image source. In this example, the digital graphic design computing system 100 establishes a communication session with a host computing system from which the online image source is available, requests the input graphic from the host computing system, and receives a copy of the input graphic in response to the request.

In some aspects, the brand engine 104 can extract, from a brand exemplar or other electronic content, one or more text elements that can be used as input text in a content-creation process performed by the design engine. For instance, the brand engine 104 can access an electronic document (e.g., a website, historical content generated by the digital graphic design computing system 100, etc.) and perform a textual analysis on the electronic document. The textual analysis can identify one or more text elements within the electronic document. The brand engine 104 can present, via a profile-development interface 106 or another suitable interface, a set of one or more text elements for selection as candidate text elements. The brand engine 104 can receive, via the profile-development interface 106 or another suitable interface, user input that selects one or more of the presented text elements as candidate text elements. The brand engine 104 can store one or more candidate text elements in a brand profile 114 or other suitable data structure (e.g., a user profile that includes or is otherwise associated with the brand profile 114). In the process 400, the design engine 108 can implement one or more of blocks 402 and 404 by presenting candidate text elements in a menu (e.g., a drop-down menu from a text field, a pop-up window overlaid on a content-creation interface 110, etc.), receiving a selection of a candidate text element via the content-creation interface 110, and selecting that candidate text element as the input text element of block 404.

In some aspects, the brand engine 104 can limit which text elements are presented in a profile-development interface 106. For instance, the brand engine 104 can select, for the profile-development interface 106, text elements meeting some frequency-of-use criterion and exclude, from the profile-development interface 106, text elements that fail to meet the frequency-of-use criterion. In one example, the brand engine 104 can rank text elements based on how frequently they occur in the text (e.g., phrase “come to the show” occurring in 20% of the text, the phrase “great deal” occurring in 40% of the text, etc.). The brand engine 104 can select a subset of the identified text elements based on their rank. For instance, the most common text elements (e.g., the three most frequently occurring phrases) may indicate that certain text elements are more important, or the least common text elements (e.g., the three most frequently occurring phrases) may indicate that they are more appropriate because they are more distinctive as compared to the rest of the detected text. Additionally or alternatively, the brand engine 104 can select text elements based on a threshold frequency (e.g., text elements that occur in more than 60% of the detected text, text element that occur in less than 10% of the detected text, etc.).

The process 400 also involves identifying one or more permissible text features for displaying the input text in accordance with a brand profile, as depicted at block 406. For instance, the design engine 108 accesses a brand profile 114 from the brand profile repository 112. The design engine 108 identifies, from font attributes 116 of the accessed brand profile 114, one or more permissions and/or prohibitions for displaying the input text. For instance, the design engine identifies one or more permissible font types, one or more permissible font styles, one or more permissible font sizes, one or more permissible font colors, etc.

The process 400 involves identifying one or more permissible visual features for displaying the input graphic in accordance with a brand profile, as depicted at block 408. For instance, the design engine 108 accesses a brand profile 114 from the brand profile repository 112. The design engine 108 identifies, from the accessed brand profile 114, one or more permissions and/or prohibitions for displaying the input graphic. In one example, the design engine 108 identifies, from color attributes 118, one or more permissible colors that can be displayed with the input graphic (e.g., permissible background colors on which to position the input graphic, permissible partially-transparent colors to be overlaid on the input graphic, etc.).

In some aspects, the design engine 108 identifies, from graphical attributes of the accessed brand profile 114, one or more criteria with which the input graphic must comply. For instance, a graphical attribute 120 may include one or more rules indicating that an input graphic must include certain content (e.g., a picture of a product) or lack certain content (e.g., a picture of a competitor's product). The design engine 108 can apply one or more machine learning algorithms or other image-processing algorithms to the input graphic to determine if the input graphic complies with the rule. For instance, the design engine 108 can apply one or more machine learning algorithms or other image-processing algorithms that classify objects depicted in the input graphic. If the object classification violates a rule from the graphical attribute 120, the design engine 108 can perform one or more remedial actions. Examples of remedial actions include ignoring the input graphic in a content-creation process (i.e., creating output branded design content 130 without the user-specified input graphic); cropping, masking, or otherwise modifying the input graphic such that an object from the input graphic that violates the rule is not displayed within the output branded design content 130; and transmitting a prompt, via the instance of the content-creation interface 110 on the user device 126, to identify a different input graphic.

The process 400 also involves identifying one or more additional elements to be displayed with the input graphic and input text, as depicted at block 410. For instance, the design engine 108 accesses a brand profile 114 from the brand profile repository 112. The design engine 108 identifies, from the accessed brand profile 114, one or more permissions and/or prohibitions for displaying additional elements with the input graphic.

In one example, the design engine 108 identifies, from one or more logo attributes 122 of the accessed brand profile 114, logo content for inclusion in the output branded design content. For instance, the design engine 108 can retrieve, from a memory device, any logo content specified by a user, any variant of the logo content generated by the brand engine 104, or some combination thereof.

In another example, the design engine 108 identifies, from one or more graphical attributes 120 of the accessed brand profile 114, additional images or other graphics for inclusion in the output branded design content. For instance, the design engine 108 can retrieve, from a memory device, any graphical content assigned to the brand profile 114 using the brand engine 104 (e.g., images or graphics uploaded via a user device 126, images or graphics extracted from one or more brand exemplars, etc.). In some aspects, all available images or other graphics associated with the accessed brand profile 114 can be selected as candidates for inclusion. In additional or alternative aspects, only some of the available images or other graphics associated with the accessed brand profile 114 can be selected as candidates for inclusion. For instance, the design engine 108 could apply a machine learning algorithm that assesses a semantic similarity between the input graphic and additional graphics associated with the brand profile 114, a stylistic similarity between the input graphic and additional graphics associated with the brand profile 114, or both. The design engine 108 could select, as candidates for inclusion, certain additional graphics that are sufficiently similar to the input graphic (semantically or stylistically) or that are sufficiently different from to the input graphic (semantically or stylistically).

The process 400 also involves generating output branded design content 130 based on a combination of the permissible text features of the input text, the permissible visual features of the input graphic, and the identified additional elements (e.g., images or other graphics, logo content, etc.) for inclusion in the output branded design content, as depicted at block 412. For instance, the design engine 108 generates a content layout that includes the input text, the input graphic, and additional content in a manner that does not violate any constraints identified in blocks 406, 408, and 410. In one example, the design engine 108 selects a combination of permissible font attributes for the text identified at block 406, a permissible color for the background identified at block 408, and a logo identified at block 410. The design engine 108 arranges these elements in a layout for one or more communication channels (e.g., layouts compliant with or suitable for email, different social media channels, banner ads on a website, etc.).

In some aspects, block 412 involves identifying one or more personality attributes 124 of the accessed brand profile 114. The design engine 108 modifies the layout, selected colors, or other visual characteristics of the output branded design content 130 to comply with one or more personality attributes. For instance,_.

The process 400 also involves outputting the output branded design content 130, as depicted at block 414. The design engine 108 can implement block 414 in any suitable manner. In one example, the design engine 108 can output the output branded design content 130 by transmitting the output branded design content 130 to one or more user devices 126, one or more target devices 132, or some combination thereof. In another example, the design engine 108 can output the output branded design content 130 by storing the output branded design content 130 in a non-transitory computer-readable medium that is accessible, via one or more data networks 134, to one or more user devices 126, one or more target devices 132, or some combination thereof.

In some aspects, the design engine 108 can restrict permissible modifications to the branded design content that may be implemented via a content-creation interface 110. For instance, a preview section of the content-creation interface 110 can be updated, at block 414, to display a preview of the branded design content 130. The design engine 108 can receive, via the content-creation interface, an edit input identifying a modification to the branded design content 130. The design engine 108 can constrain, augment, or reject the modification based on a constraint indicated by the brand profile, a quality requirement assessed by a design-quality model (described in more detail below), or both.

In an example involving constraints on a user-provided modification, the design engine 108 can limit the editing options available via the content-creation interface. For instance, the design engine 108 can exclude certain options from a content editing tool or deactivate certain options, thereby preventing the content-creation interface 110 from receiving user inputs selecting certain edits that are inconsistent with attribute values in a brand profile. Examples of excluding or deactivating certain options include excluding or deactivating options to select certain font types in a text-editing tool, excluding or deactivating options to select certain font sizes in a text-editing tool, excluding or deactivating options to select colors that are inconsistent with color attributes 118 (e.g., limiting a set of available colors to the color palette included in the brand profile) in a text-editing tool or a graphic-editing tool, excluding or deactivating options to modify imagery or graphics that are inconsistent with graphical attributes 120 (e.g., available background colors, overlay colors, border colors, etc.) using a graphic-editing tool, etc.

In some aspects, the design engine 108 can apply different constraints to different regions of design content. For instance, design content generated by the design engine 108 could include a first block in which text elements are positioned and a second block in which graphics are positioned. The design engine 108 can identify any constraints associated with text and any constraints associated with imagery. The design engine 108 can exclude certain or deactivate certain options in one region based on the identified constraints for that region, while allowing the use of those options in a different region that lacks those constraints. In a simplified example, a certain color may be prohibited from being used as the background for text in a font attribute 116, whereas a graphical attribute 120 may lack any similar prohibition on using the same color as the background for a graphic. If a color-selection tool is invoked with respect to a block containing text (e.g., by right-clicking on the text and selecting the color-selection tool from a contextual menu), the design engine 108 can omit that color from the set of available colors for the color-selection tool. But if the color-selection tool is invoked with respect to a block containing a graphic (e.g., by right-clicking on the graphic and selecting the color-selection tool from a contextual menu), the design engine 108 can include that color in the set of available colors for the color-selection tool.

In an example involving augmentation of a user-provided modification, the design engine 108 can determine that the modification would cause the design to violate a constraint indicated by the brand profile or a quality requirement assessed by a design-quality model. For instance, removing certain text from the center a design may cause the remaining text in the design to violate a quality requirement (e.g., a requirement that all text must be substantially centered), or adding text to a text block may cause the text to extend over an area having a prohibited background color for the text. The design engine 108 can augment the user-specified modification by performing one or more additional modifications that prevent the design from violating the brand profile or quality constraint. In the examples above, the design engine 108 could re-position any text that remains after deleting certain text, thereby preventing the design from violating a “substantially centered text” constrain, or could modify the width and height of a text block such that added text does not extend into an area having a prohibited background color.

In another example involving rejection of a user-provided modification, the design engine 108 can determine that the modification itself violates a constraint indicated by the brand profile or a quality requirement assessed by a design-quality model. Examples of such constraints could include constraints on one or more permissible text features specified by the font attribute, one or more permissible visual features specified by a color attribute or a graphical attribute, etc. The design engine 108 can reject the modification specified by the edit input based on determining that the modification violates the constraint.

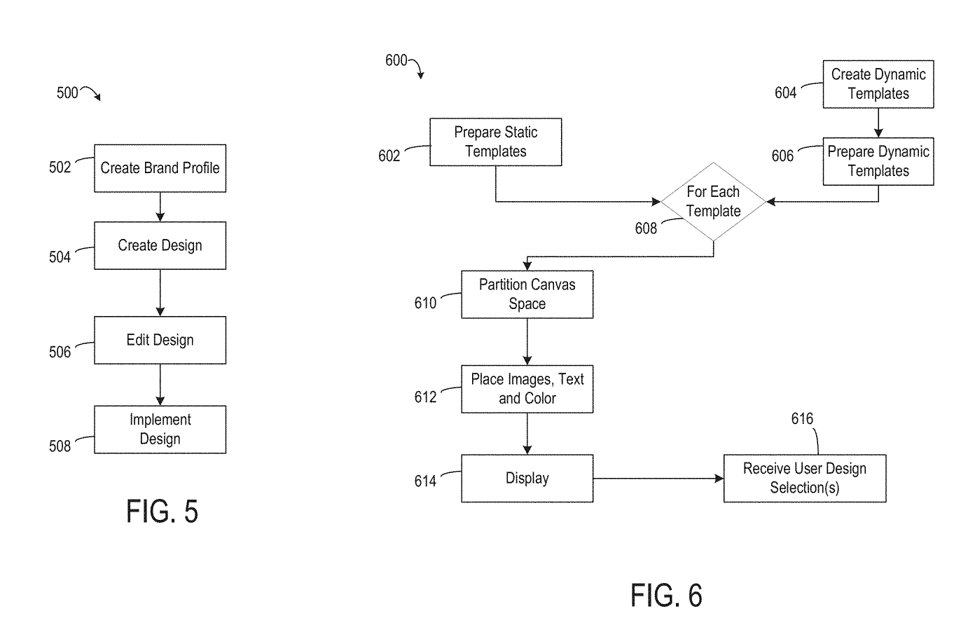

FIG. 5 depicts an example of process 500 that the digital graphic design computing system 100 could perform to produce output branded design content 130. In some aspects, one or more computing devices, such as a digital graphic design computing system 100 and/or a user device 126, implement operations depicted in FIG. 5 by executing suitable program instructions (e.g., the client application 128, one or more of the engines depicted in FIG. 1, etc.). For illustrative purposes, the process 500 is described with reference to certain examples depicted in the figures. Other implementations, however, are possible.

At block 502, a brand may have one or more brand profiles created. Block 502 may be implemented by, for example, the process 300 described above. A brand profile can be, for example, a data set describing the characteristics and limitations of a particular brand, similar to a virtualized version of a brand book. The created brand profiles may define such characteristics as one or more colors that are preferred to be used with a brand, text styles, logos, stock photos, brand personalities (e.g., “dynamic” versus “traditional”), and other similar characteristics. The created brand profiles may also define restrictions on a brand, such as identifying colors or text styles that may not be used with a brand even when manually selected or overridden by a user. A particular company may only have one brand profile that is used in all instances, or may have a number of specialized brand profiles (e.g., a profile for general marketing, a profile for job fairs, various geographically linked profiles).

At block 504, one or more designs may be created using, as input, brand profiles and user inputs from a user via the user device 126. Block 504 may be implemented by, for example, the process 300 described above. User input received could include an image size, text headline, and body text, which could be paired with the brand characteristics associated with the brand profile in order to generate a number of provisional designs. Provisional designs could be automatically generated using pre-configured static templates, dynamically generated templates, or both. Templates would partition the user specified canvas space available for an image into different sections, then place brand colors and logos, and user provided text and photographs automatically. The user may then select one or more provisional designs to finalize.

At block 506, user inputs that edit one or more of the designs may be received, and the client application 128 and/or the digital design application 102 can edit one or more of the designs. Examples of edits could include moving or resizing partitions, changing colors, logos, photos, and text. Each manual change indicated by inputs from a user device 126 may be compared to the brand profile to determine whether the manual change is an allowable change, or whether the manual change is prohibited based upon the brand profile. Once changes have been rejected or accepted based upon the brand profile, the design is finalized and ready for publication.

At block 508, one or more designs generated with the digital graphic design computing system 100 can be implemented, For instance, if designs are ready for implementation or publication, the digital graphic design computing system 100 may automatically distribute the designs to one or more platforms or recipients. Distributing the designs could include pushing the designs to advertisers, social media, print providers, copyrighters, or other recipients. The digital graphic design computing system 100 may also produce a proprietary dataset describing the designs that may be shared between users of the digital graphic design computing system 100 for easy maintenance of the designs. For example, the proprietary dataset may be automatically produced by an employee of a business using the tools and interfaces of the digital graphic design computing system 100, and then shared with a graphic designer with instructions to further refine, tweak, or modify the design before publication. The graphic designer may receive the proprietary dataset and view it using a tool or interface of the digital graphic design computing system 100, or may use the digital graphic design computing system 100 to convert the proprietary dataset into whatever format the graphic designer prefers to work within.

A brand profile could be created in any suitable manner. In one example, the digital graphic design computing system 100 may be configured to display a profile-development interface 106 to users via the user device 126. The profile-development interface 106 may be, for example, an interactive website or software application, or other type of interface. In some aspects, the digital graphic design computing system 100 may receive manual brand input from the user device, which could be in the form of data submitted based upon text entered into input boxes, options selected from menu boxes, button clicks or radio button selections, color palette selections from a color grid, uploaded logos, photographs, and other images, audio, video, or other information relating to a brand.

In some aspects, the digital graphic design computing system 100 may also receive prior brand input. The prior brand input could provide or identify brand exemplars (i.e., prior examples of content with the brand). These brand exemplars could include one or more of a file upload of a brand book in any of a variety of formats, digital images of graphic designs, products, or business locations associated with the brand, or web search results associated with the brand. Prior brand input that is received may be processed by the digital graphic design computing system 100 to extract one or more brand characteristics automatically and reduce or remove the necessity for receiving manual brand input.

For example, automatically extracting one or more brand characteristics could include a visual analysis of a brand book, digital images, search results or web pages, or business location to identify one or more colors associated with the brand, text styles associated with the brand, or logos and digital imagers associated with the brand. Such analysis could also include visual analysis of the same sources to determine a brand personality, where, for example, text, colors, and layouts detected within the imagery could suggest that the brand might be more modern than traditional (e.g., use of certain colors or shapes that suggest modern design), more funny than serious (e.g., use of certain font styles that suggest humor or a relaxed nature), more intellectual than physical (e.g., balance of text versus images in brand examples).

Prior brand example analysis could also include textual analysis of a brand book, digital images, web site, or web search results to determine one or more characteristics of the brand. For example, this could include textual analysis of a brand book, website, or search results to extract color codes, text styles, keywords or phrases associated with the brand, or textual analysis of a web site or search results to determine brand personality, such as identifying descriptions or social media conversations that may suggest the brand is modern, funny, edgy, formal, aggressive, or other characteristics.

Having received manual brand input, received prior brand input, or both, the digital graphic design computing system 100 can build the brand profile by configuring brand color palette and restrictions. This could include using the received input to identify one or more primary colors associated with the brand, one or more secondary colors associated with the brand, and one or more color restrictions associated with the brand. For example, one brand may have blue as a primary color associated with red as a secondary color, as well as blue as a primary color associated with white as a secondary color. The same brand may have a competitor that uses blue as a primary color associated with yellow as a secondary color, so yellow might be entirely restricted, or might be restricted from use with blue.

The digital graphic design computing system 100 may also configure typography for the brand. As with color, the digital graphic design computing system 100 can use the received inputs to determine primary and secondary fonts that are used with the brand, as well as potentially fonts that are used by the brand's competitors or are otherwise restricted from use. For example, one brand may use Times New Roman as a primary font and Arial as a secondary font, but may restrict the use of Comic Sans for primary or secondary use. The digital graphic design computing system 100 may also configure one or more brand logos to be used with the brand based upon the received inputs. The digital graphic design computing system 100, may also configure one or more photographs to be used with the brand based upon the same. Brand logos may include trademarks or other textual and visual designs that a brand may use to identify itself and to provide an indication of the source of a product or service. Brand photographs may include images associated with the brand that are not logos, such as images of the brands headquarters, executives, products, or other images. Brand photographs may also include numerous stock images or other images that the brand has purchased, licensed, or otherwise holds the rights to for use with graphic designs.

Having received inputs and configured a number of aspects or characteristics of a brand based thereon, the digital graphic design computing system 100 may finalize and save the newly created brand profile. The brand profile may be associated with a certain business or businesses, such that any user associated with that business may access the brand profile from the digital graphic design computing system 100, or may be associated with one or more individual users of the digital graphic design computing system 100.

A user may use the brand profile to cause the digital graphic design computing system 100 to produce a number of provisional graphic designs based thereon. For example, the digital graphic design computing system 100 may cause a user device 126 to display a content-creation interface 110. A content-creation interface 110 can include control elements such as text inputs, drop down menus, selection menus, radio buttons, and other similar inputs. The digital graphic design computing system 100 may then receive inputs from the user device 126, such as receiving a brand profile selection that will be used to determine the appearance of and restrictions on the provisional graphic designs. Another input could specify a canvas size for the graphic designs in pixels, inches, centimeters, or other measurements. Another input could provide text content for the graphic design (e.g., a headline, a sub-line, a body, a footer, etc.). Another input could provide image content for the graphic design (e.g., selecting from photographs configured for the brand or uploading new photographs). Another input could include an indication of whether or not a configured brand logo should be included in the provisional graphic designs.

While it is contemplated that the above information will be received via the content-creation interface 110, it should also be understood that it could be submitted via other forms such as electronic mail or software interface and could be automatically parsed and accepted by the digital graphic design computing system 100. Further, it should be understood that in some implementations the above content could be automatically generated (e.g., based upon prior brand examples or brand website scraping, based upon randomly selected or generated generic language, or a combination of the two) and provided to the digital graphic design computing system 100 such that novel output branded design content 130 could be produced in an entirely automatic fashion.

At this point, the digital graphic design computing system 100 already has access to all or substantially all of the content (e.g., text, images, colors, fonts) that will be present on the provisional graphic designs, but its output position, size, and placement relative to other components has yet to be determined.

The digital graphic design computing system 100 may produce and display a set of provisional graphic designs based thereon for a user to review and select, as shown in the process 600 in FIG. 6. In some aspects, one or more computing devices, such as a digital graphic design computing system 100 and/or a user device 126, implement operations depicted in FIG. 6 by executing suitable program instructions (e.g., the client application 128, one or more of the engines depicted in FIG. 1, etc.). For illustrative purposes, the process 600 is described with reference to certain examples depicted in the figures. Other implementations, however, are possible.

At block 602, the design engine 108 can select and prepare to use one or more static templates. Templates can provide partitions or sections for various canvas sizes, and may also define which partitions or sections are appropriate for what type of content (e.g., primary color, secondary color, headline, body, brand logo, photograph). Static templates are pre-configured templates that may be selected based upon brand preference factors such as brand personality or manual preference. The design engine 108 may have a pool of static templates available to any brand, which may grow over time as administrators of the design engine 108 add additional templates, and may also have separate pools of static templates that are only available to certain users or premium users of the digital graphic design computing system 100. One advantage of static templates is that a graphic designer or other professional can design them ahead of time using their own skill and expertise. As a result, graphic designs that are generated using static templates may be more aesthetically pleasing for some.

At block 604, the design engine 108 can create one or more dynamic templates. At block 606, the design engine 108 can select and prepare one or more dynamic templates. Dynamic templates may be automatically created on demand and then selected and prepared for use. Dynamic templates may be created by an automated process that simulates some of the decisions a graphic designer or other professional would make when generating static templates. Being machine driven, dynamic templates can be created near-instantaneously to offer additional options beyond static templates. In some implementations, creation of dynamic templates at block 604 may follow certain decision paths, with some level of randomness used by the process to select one or more branching paths throughout. In other implementations, creation of dynamic templates at block 604 may be user or brand specific or brand profile specific, and may use machine learning systems and principles in order to, over time, begin to recognize and eventually predict the types of dynamic templates that a user will prefer.

At block 608, the design engine 108 selects a template for a given iteration. The process 600 will iterate. For each available template selected at block 608, the design engine 108 can partition the canvas space based upon the particular template, as depicted at block 612. The design engine 108 can also place (410) images, text and color based upon the particular template to produce a provisional graphic, as depicted at block 612. The design engine 108 may accomplish placement by, for example, programmatically generating image data (e.g., as a JPG, BMP, or other image format) based upon the particular template and inputs, may render or draw the graphic design within an application (e.g., rendering the design with objects from an object oriented language, drawing on an HTML canvas), or may simulate the graphic design by creating and organizing a number of HTML components to appear as the graphic design. The particular implementation will depend on factors such as the manner in which the user interacts with the design engine 108 (e.g., through a web browser or through an installed application) and other factors that will be apparent to one of ordinary skill in the art in light of this disclosure.

At block 614, the design engine 108 can display one or more provisional graphic designs that have been produced. The designs may be displayed, at block 614, via an instance of the content-creation interface 1100 presented on the user device 126. Being an automated process capable of quickly generating many graphic designs based upon static templates and dynamic templates, there may be a level of uncertainty or randomness that may commonly produce provisional graphic designs that are either entirely undesirable, or are undesirable for a certain user or brand.

At block 616, the design engine 108 can, responsive to user input from the user device 126, browse the displayed provisional graphic designs and submit selections of one or more approved or preferred designs to be received by the design engine 108. The selected provisional graphic designs may be preserved, and unselected provisional graphic designs may be discarded. The design engine 108 may keep some information relating to selected and unselected provisional graphic designs, as this provides a data source that may be used to fine tune both decision tree processes and machine learning processes to provide more desirable templates and graphic designs to a user over time. Additionally, while selecting their preferred graphic designs, users may also be able to submit information such as an order of their favorite designs, an order of their least favorite designs, or an indication of varying degrees of approval or disapproval for each design (e.g., a thumbs up or thumbs down, +1 or −1, star rating, etc.).

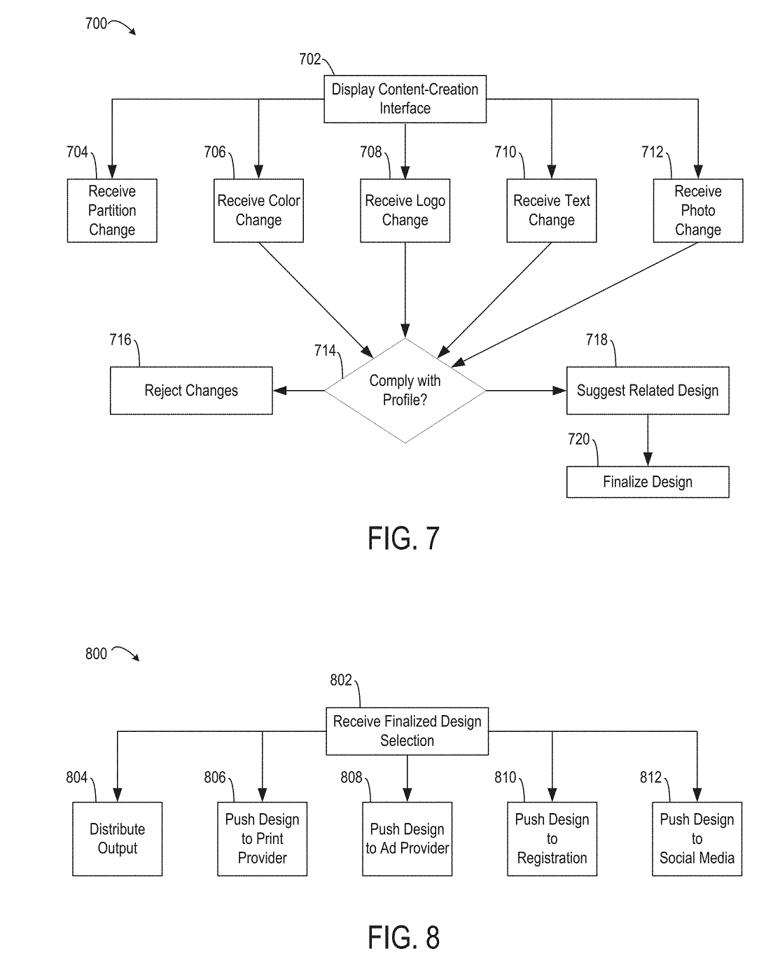

FIG. 7 depicts an example of a process 700 for making one or more edits to one or more of received provisional branded design content 130 (e.g., designs received at block 516 of the process 500). In some aspects, one or more computing devices, such as a digital graphic design computing system 100 and/or a user device 126, implement operations depicted in FIG. 7 by executing suitable program instructions (e.g., the client application 128, one or more of the engines depicted in FIG. 1, etc.). For illustrative purposes, the process 700 is described with reference to certain examples depicted in the figures. Other implementations, however, are possible.

At block 702, the design engine 108 can display a content-creation interface 110 via the user device 126. The content-creation interface 110 includes one or more control elements allowing a user to submit one or more changes to various aspects of each selected provisional graphic design. In one example, at block 704, the design engine 108 may receive a partition change that changes the size or position of a partition of the canvas. In another example, at block 706, the design engine 108 may receive a color change for a partition. In another example, at block 708, the design engine 108 may receive a logo change or deletion. In another example, at block 710, the design engine 108 may receive a text change that modifies the font, size, style, or contents of one or more text strings. In another example, at block 712, the design engine 108 may receive a photo change to move, resize, crop, replace, or delete an image or other media of the provisional graphic design.

At block 714, one or more received changes can be checked by the design engine 108 against a selected brand profile to determine whether the particular changes comply with the limitations of the brand profile. For instance, the brand profile may have whitelists of certain colors, styles, photographs, or other characteristics that are acceptable to use in graphic images, and may also have blacklists of certain colors, styles, and other characteristics.

If, at block 714, it is determined that a particular change is found to be restricted in some way, either by itself or in the context of other changes, the change will be rejected by the design engine 108, as depicted at block 716. If, at block 714, a change is determined, to be acceptable, the design engine 108 will consider the remaining provisional graphic designs to be near-final.

For example, the design engine 108 can detect a particular edit event via an event listener of the content-creation interface 110. Subsequent to detecting the edit event, and prior to implementing a modification specified by the edit (e.g., updating a preview of the design content within the content-creation interface 110), the design engine 108 can assess a design modification requested by the edit. Assessing the requested design modification can include comparing the requested design modification to the constraints and/or permissions indicated by one or more brand attributes of the brand profile. If the comparison indicates that the requested design modification is found to be restricted in some way, the design engine 108 can reject the edit. For instance, the design engine 108 can update the content-creation interface 110 to display an error message while maintaining a display of the design content without the requested design modification, or can simply ignore the requested design modification altogether. In this manner, the design engine 108 can modify a conventional operation of a graphic design tool that lacks certain aspects described herein, in that an event detected by an event listener that would normally trigger a corresponding update to digital design content (e.g., an edit to a color scheme) is intercepted and, in some cases, rejected based on the comparison to the brand profile.

At block 718, the design engine 108 can suggest one or more related graphic designs. Related graphic designs may be suggested based upon different factors, with one such factor being canvas size. For example, if a user originally selected a canvas size that is common for web advertisements, such as a 728×90 leaderboard, the design engine 108 may determine that the user may also desire versions of the graphic image in a 468×70 banner, a 250×250 square, a 160×700 wide skyscraper, or other sizes, both related to web advertisements and not (e.g., common photo sizes such as 4×7, 5×8, common even poster sizes, common slideshow sizes, common magazine, newspaper, or print sizes).

Having identified related canvas sizes that the user may desire, the design engine 108 can directly convert the graphic design to one or more new sizes where the graphic design is substantially the same proportions and where the new size will still in result in readable text and other detail. Additionally or alternatively, the design engine 108 can translate the graphic design to the new size where the proportions are different. For example, a 250×250 square graphic design may directly convert to a 500×500 square design, or even a 500×700 design, but may not easily convert to a 728×90 design. To accommodate, the design engine 108 may have translation logic that links, for example, a 500×500 template to a similarly styled 728×90 template. This allows the content of the 500×500 graphic design to be readily mapped to the 728×90 template while substantially preserving the overall style, aesthetic, and visual appearance that caused the user to select the preferred graphic design in the first place.

If a selected graphic design has been edited as desired, and related designs have been produced, selected, and potentially also edited, the design engine 108 may finalize the designs and thereby generate output branded design content 130, as depicted at block 720. Finalizing a design may include one or more of committing the design to a database in a variety of formats, converting the design from HTML or programming objects into image formats, and saving or preserving the user session and choices made throughout one or more examples described above that resulted in the graphic designs, to enable a user to more easily return to the session and tweak the designs at a later point if desired.

As graphic designs are finalized, the digital graphic design computing system 100 may take other actions. For example, FIG. 8 depicts an example of a process 800 for implementing one or more of the set of finalized designs as output branded design content 130. In some aspects, one or more computing devices, such as a digital graphic design computing system 100 and/or a user device 126, implement operations depicted in FIG. 8 by executing suitable program instructions (e.g., the client application 128, one or more of the engines depicted in FIG. 1, etc.). For illustrative purposes, the process 800 is described with reference to certain examples depicted in the figures. Other implementations, however, are possible.

As finalized designs are confirmed and received based upon user selections at block 802, the digital graphic design computing system 100 may create and distribute the designs in one or more proprietary or non-proprietary output formats describing the designs, as depicted at block 804. This could include producing and providing JPG images to one or more parties, providing complex image files (e.g., an image file appropriate for use with a graphic editing software that preserves separate elements of the graphic design as layers and objects) to graphic designers, or generating proprietary data that may be transmitted to another user of the digital graphic design computing system 100 and used with the digital graphic design computing system 100 to view the graphic designs and the user session and choices that resulted in their creation.

The digital graphic design computing system 100 may also distribute the graphic designs in a variety of formats to a print provider, as depicted at block 804. Block 804 could also include distributing instructions describing a number of print copies to be produced, a paper or material type, delivery location, payment information, and other similar information that may be desirable for the print provider to have.

The digital graphic design computing system 100 may also distribute the graphic designs to an advertisement provider via an API or other web or software interface, as depicted at block 808, to allow the graphic designs to start immediately distributing via one or more advertisement platforms. For example, upon receiving final designs, the graphic designs may be automatically provided to a third-party advertiser, along with information relating to an ad campaign, such as desired impressions, clicks, target URL, and other information that may be desirable. In this manner, a user can in a matter of minutes generate novel graphic designs and begin distributing them to a target audience in a substantially automated manner.

The digital graphic design computing system 100 may also distribute the graphic designs to one or more registration services, as depicted at block 810. This could include, for example, a registration service, individual, or group for the brand itself that is responsible for viewing, approving, and maintaining graphic designs and other materials that are produced for the brand. This could also include electronically transmitting or preparing the required papers or documents for physically or electronically transmitting the graphic designs directly to a third-party that maintains a registry of advertisements, graphic designs, or other works. For example, this could include electronically transmitting the graphic designs to an association that is responsible for approving marketing and promotional materials for a particular industry, but could also include preparing documents that may be printed and mailed with a physical copy of the graphic design to a copyright registration office in order to register the graphic design and have it placed on a federal register.

The digital graphic design computing system 100 may also distribute the graphic designs on one or more social media platforms or other platforms supporting the distribution of user generated content, as depicted at block 812. This could include transmitting the graphic designs via an API to be displayed via the brand's account, timeline, stream, or page on a social media site such as Facebook or Twitter, as well as displayed via the accounts, timelines, streams, or pages of influencers, employees, sponsors, partners, or other parties associated with the brand.

Examples of Profile-Development Interfaces

Any suitable profile-development interface can be used by the brand engine 104 to generate a brand profile. FIGS. 9-18, 21, and 22 depict examples of certain profile-development interfaces that can be provided from the brand engine 104 to a user device 126 and that can be used by the brand engine 104 to develop a brand profile 114. Other implementations, however, are possible. For instance, one or more graphical elements or control elements from the interfaces depicted in one or more of FIGS. 9-18, 21, and 22 can be combined with one or more other graphical elements or control elements from the interfaces depicted in one or more of FIGS. 9-18, 21, and 22. In the examples depicted in FIGS. 9-18, 21, and 22, specific attribute values and/or corresponding visualizations of the attribute values can be specified via one or more user inputs, determined from an analysis of a brand exemplar, or some combination thereof. A visualization of an attribute value (e.g., a color, a text attribute, etc.) can include any graphical or textual element in a user interface that provides a visual presentation of the attribute value.

As discussed above with respect to FIG. 1, another example of a brand attribute is a color attribute. FIG. 9 depicts an example of a profile-development interface 900 for configuring one or more color attributes of a brand profile. The profile-development interface 900 depicted in FIG. 9 includes a section-selection menu 902 in which a color option 903 has been selected, a color palette section 904, and a role-selection section 910.

The color palette section 904 includes a first set of visualizations 906 identifying colors that have been selected as primary colors. The color palette section 904 also includes a second set of visualizations 908 identifying colors that have been selected as secondary colors. In some aspects, as depicted in the example of FIG. 9, different color visualizations can be used to indicate a color attribute value. For instance, if one or more color attributes identify a first color as a primary color and identify a second color as a secondary color, the design engine 108 can cause the first color to be included in the visualizations 906 and the second color to be included in the visualizations 908. The design engine 108 can render the profile-development interface 900 with the visualizations 906 for the primary colors positioned together in a different area than the visualizations 908 for the secondary colors, thereby indicating a difference in priority for the two sets of colors. Additionally or alternatively, the design engine 108 can render the profile-development interface 900 with the visualizations 906 for the primary colors having a larger size (e.g., larger radius) than the visualizations 908 for the secondary colors, thereby indicating a difference in priority for the two sets of colors.

The role-selection section 910 can include a set of one or more visualizations 912 identifying colors available for a brand (e.g., the primary and secondary identified via the color palette section 904). The role-selection section 910 can also include a set of control elements 913 that can receive input indicating a role for the colors identified in the visualizations 912. An example of a set of control elements 913 is a set of checkboxes respectively corresponding to the colors identified in the visualizations 912. If the design engine 108 receives, via the profile-development interface 900, a selection of one of the control elements 913, the design engine 108 can access a color attribute for the color corresponding to the selected control element (e.g., a color represented in corresponding one of the visualizations 912). The design engine 108 can update the accessed color attribute to indicate that the color has the role.

The role-selection section 910 can also include one or more previews 914 having visualizations that depict the use of a given color in a given role. For instance, each of the previews 914 depicts an example of text set against a respective background color identified using the one or more of the control elements 913. Additional control elements 916 can be used to select, as a primary text color or accent text color, another one of the colors identified in the visualizations 912. For instance, if the design engine 108 receives, via the profile-development interface 900, a selection of one of the control elements 916, the design engine 108 can access a color palette specified by a set of color attributes for the brand profile (e.g., the set of colors indicated by visualizations 906 and 908). The design engine 108 can display a menu element for selecting one of the colors as a text color, an accent color, or both. The design engine 108 can respond to a user input selecting one of the colors from the menu by updating a suitable color attribute, font attribute, or both to indicate that a given background color should be paired with a given text color.

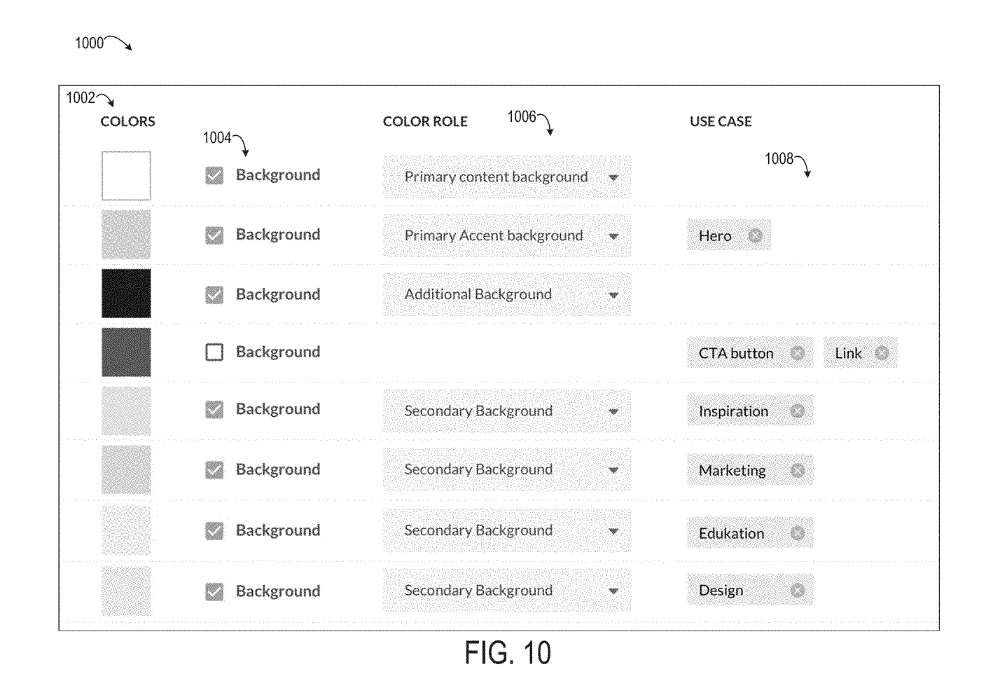

FIG. 10 depicts an example of a profile-development interface 1000 for configuring one or more color attributes that control, in a brand profile, how certain colors can be used. In this example, the profile-development interface 1000 includes a set of visualizations 1002 depicting examples of primary and secondary colors from FIG. 10. The profile-development interface 1000 also includes a set of control elements 1004 respectively corresponding to the colors depicted by the visualizations 1002. The control elements 1004 can be selected, which can set the values of certain color attributes such that the colors are identified as background colors. The profile-development interface 1000 also includes a set of control elements 1006 respectively corresponding to the colors depicted by the visualizations 1002. The control elements 1006 can be selected, modified, or otherwise manipulated, which can set the values of certain color attributes such that the colors are identified as different types of background colors (e.g., primary accent, secondary background, etc.). The profile-development interface 1000 also includes a set of control elements 1008 respectively corresponding to the colors depicted by the visualizations 1002. The control elements 1008 can be selected, modified, or otherwise manipulated, which can set the values of certain color attributes such that the roles in which the colors are used are controlled (e.g., by adding certain permissible roles for a color, removing certain permissible roles for a color, etc.).

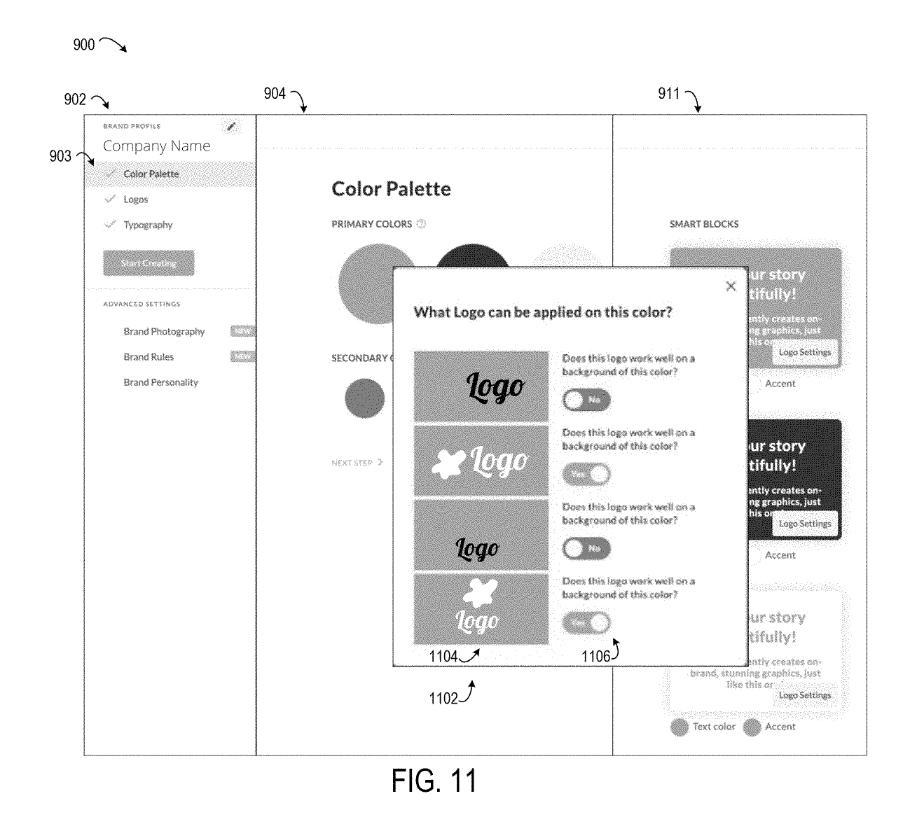

In some aspects, one or more logo attributes 122 can be configured from a profile-development interface that is used to configure one or more color attributes 118. For instance, FIG. 11 depicts an example of a logo-configuration interface 1102 overlaid on the profile-development interface 900. The logo-configuration interface 1102 could be surfaced by, for example, right-clicking on a particular color in the color palette section 904 and selecting an option for configuring certain logo attributes. In this example, the logo-configuration interface 1102 can include a set of visualizations 1104 depicting one or more logo elements, such as different logo variants, set against a background color that is one of the colors identified in the visualizations 912. The logo-configuration interface 1102 can also include one or more control elements 1106 configured for receiving input indicating whether the background color can be used with a respective logo variant. For instance, the tool depicted in FIG. 11 can be used for updating, based on input to the tool (i.e., logo-configuration interface 1102), a logo attribute of the brand profile to identify the modified color specified with the tool; updating, based on input to the tool, a logo attribute of the brand profile to prevent a modified color specified with the tool from being displayed adjacent to the logo element; or some combination thereof.

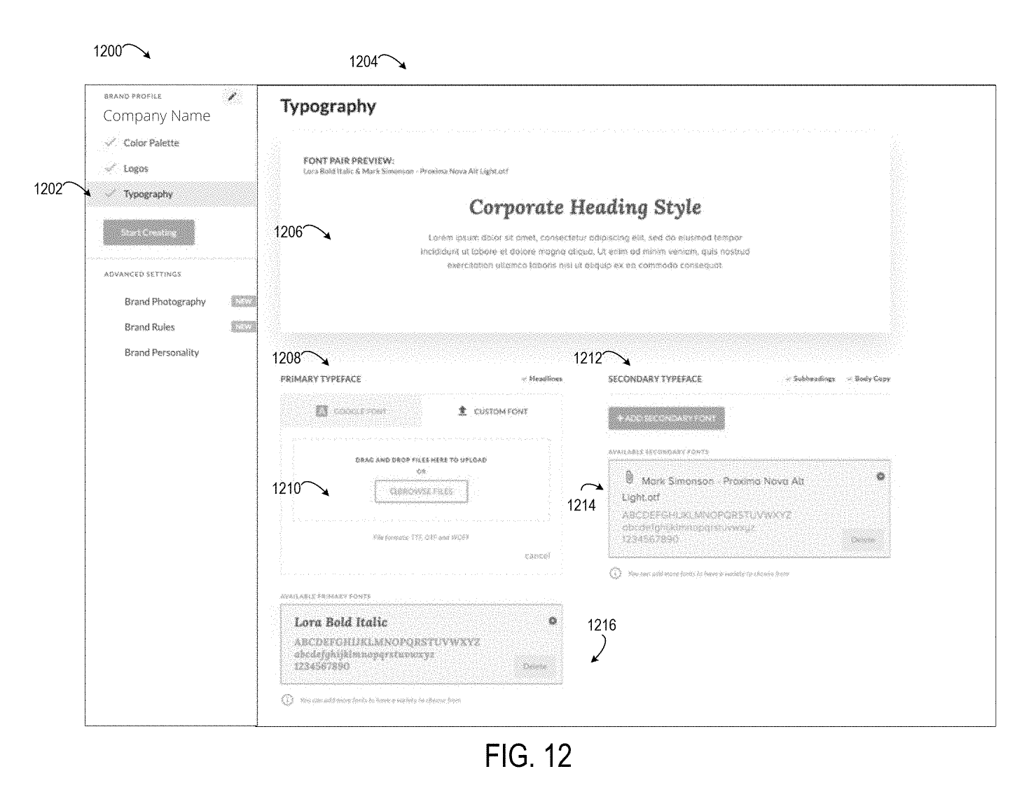

As discussed above with respect to FIG. 1, another example of a brand attribute is a font attribute. FIG. 12 depicts an example of a profile-development interface 1200 for configuring one or more font attributes in a brand profile. In this example, a font configuration option 1202 has been selected. The profile-development interface 1200 can include a font configuration section 1204. The font configuration section 1204 can include a preview section 1206, a primary typeface configuration section 1208, and a secondary typeface configuration section 1212. In this example, the primary typeface configuration section 1208 includes a preview 1216 of a selected primary typeface, and the secondary typeface configuration section 1212 includes a preview 1214 of a selected secondary typeface. The primary typeface configuration section 1208 and/or the secondary typeface configuration section 1212 can also include a selection tool for selecting a typeface. For example, in FIG. 12, the primary typeface configuration section 1208 includes a selection tool 1210 that includes drag-and-drop functionality for uploading a font file.

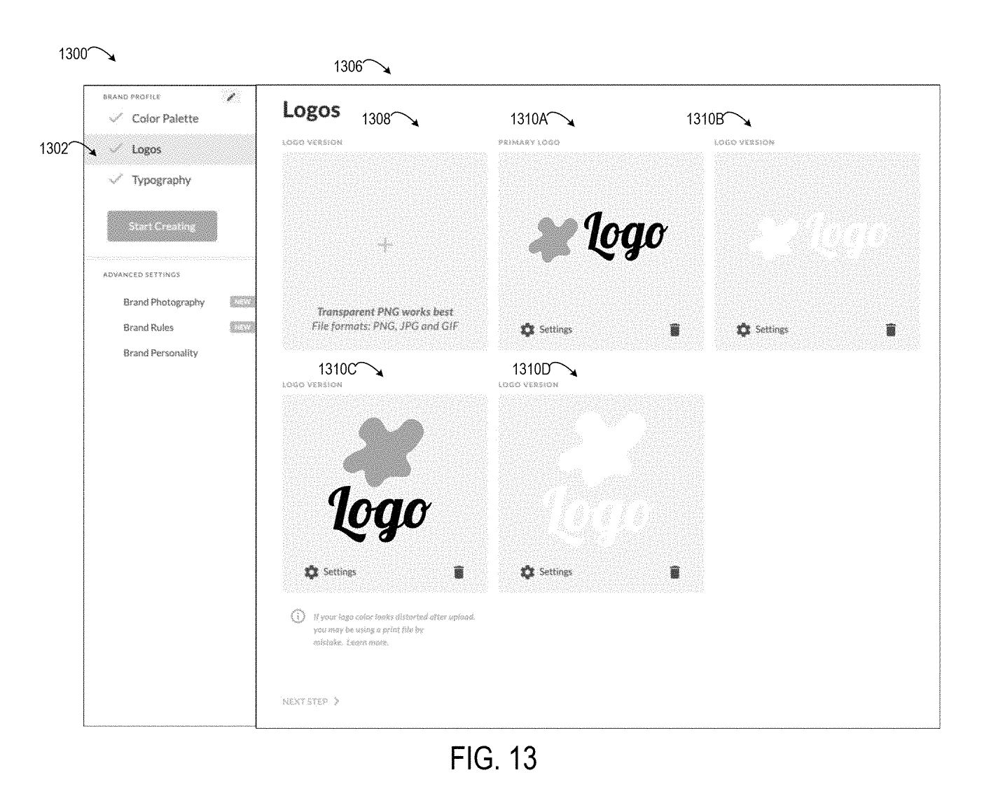

As discussed above with respect to FIG. 1, another example of a brand attribute is a logo attribute. FIG. 13 depicts an example of a profile-development interface 1300 for configuring one or more logo attributes in a brand profile. In this example, a logo configuration option 1302 has been selected. The profile-development interface 1300 can include a logo configuration section 1306. The logo configuration section 1306 can include visualizations 1310A-D depicting different logo variants that have been uploaded using the user device 126, generated by the brand engine 104, or both. The logo configuration section 1306 can also include a logo selection tool for uploading or otherwise selecting a particular graphics file having a logo variant.

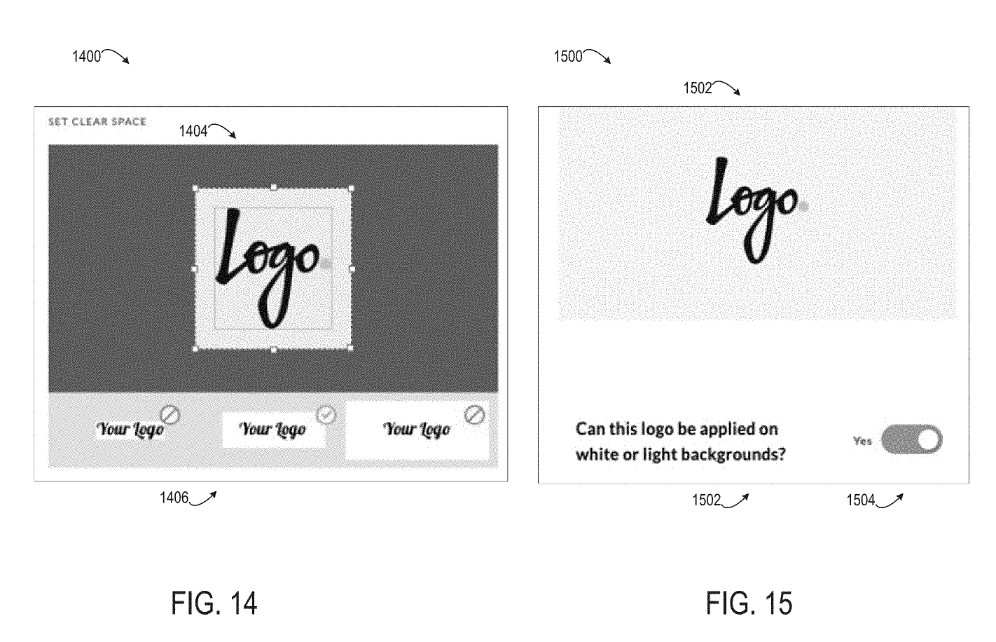

FIG. 14 depicts an example of a profile-development interface 1400 for configuring one or more logo attributes controlling how a logo can be cropped. In this example, the profile-development interface 1400 can include a manual cropping section 1404 configured for receiving user inputs that specify a desired amount of white space (i.e., a desired cropping) of a particular logo variant. The profile-development interface 1400 can also include an automated cropping section 1406 configured for presenting cropping suggestions generated by the branding engine 104. The automated cropping section 1406 can be configured for receiving user inputs that accept or reject a particular cropping suggestion (e.g., adding a check mark to accepted cropping suggestions.

FIG. 15 depicts an example of a profile-development interface 1500 for configuring one or more logo attributes controlling the type of backgrounds to which a logo can be applied. In this example, the profile-development interface 1500 can include a preview section 1502 configured for presenting a visualization of a particular logo variant against a particular background color or a particular type of background (e.g., a background color that is predominantly white or light-colored). The profile-development interface 1500 can also include a control section 1504 having a control element configured for accepting or rejecting a particular type of background for the particular logo variant depicted in the preview section 1502. For instance, the tool depicted in FIG. 15 can be used for updating, based on input to the tool (i.e., logo-configuration interface 1502), a logo attribute of the brand profile to identify the modified color specified with the tool; updating, based on input to the tool, a logo attribute of the brand profile to prevent a modified color specified with the tool from being displayed adjacent to the logo element; or some combination thereof.

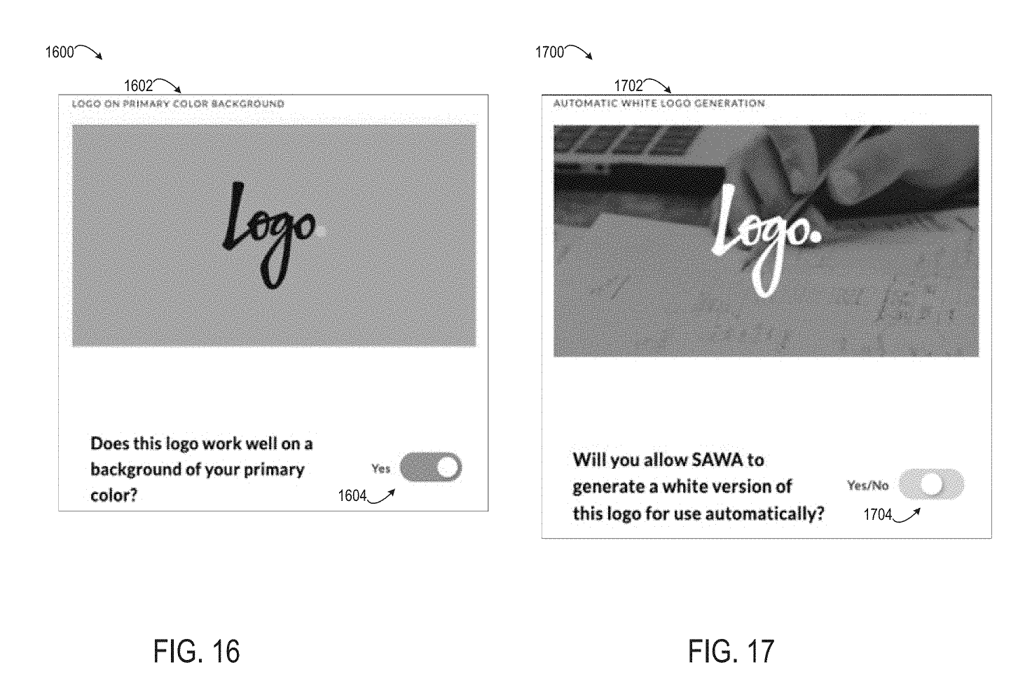

FIG. 16 depicts an example of a profile-development interface 1600 for configuring one or more logo attributes controlling the type of backgrounds to which a logo can be applied. In this example, the profile-development interface 1600 can include a preview section 1602 configured for presenting a visualization of a particular logo variant against a particular color that has been identified as a background color (e.g., via the profile-development interface 900). The profile-development interface 1600 can also include a control section 1604 having a control element configured for accepting or rejecting a particular background color for the particular logo variant depicted in the preview section 1602. Thus, the tool depicted in FIG. 16 can be used for updating, based on input to the tool (i.e., logo-configuration interface 1602), a logo attribute of the brand profile to identify the modified color specified with the tool; updating, based on input to the tool, a logo attribute of the brand profile to prevent a modified color specified with the tool from being displayed adjacent to the logo element; or some combination thereof.

FIG. 17 depicts an example of a profile-development interface 1700 for configuring one or more logo attributes controlling whether the branding engine can automatically generate a logo variant. In this example, the profile-development interface 1700 can include a preview section 1702 configured for presenting a visualization of a particular logo variant generated by the brand engine 104. The profile-development interface 1700 can also include a control section 1704 having a control element configured for identifying permissions for (or constraints on) the brand engine 104 generating a particular type of logo variant (e.g., replacing black text with white text, generating a black-and-white version of a color logo, generating a variant of a given logo graphic by inverting all colors of the logo graphic, etc.). The interface depicted in FIG. 17 that therefore provide a tool for modifying a color used to display a logo element and updating, based on input to the tool, the brand profile to include a logo variant having a modified color specified with the tool.

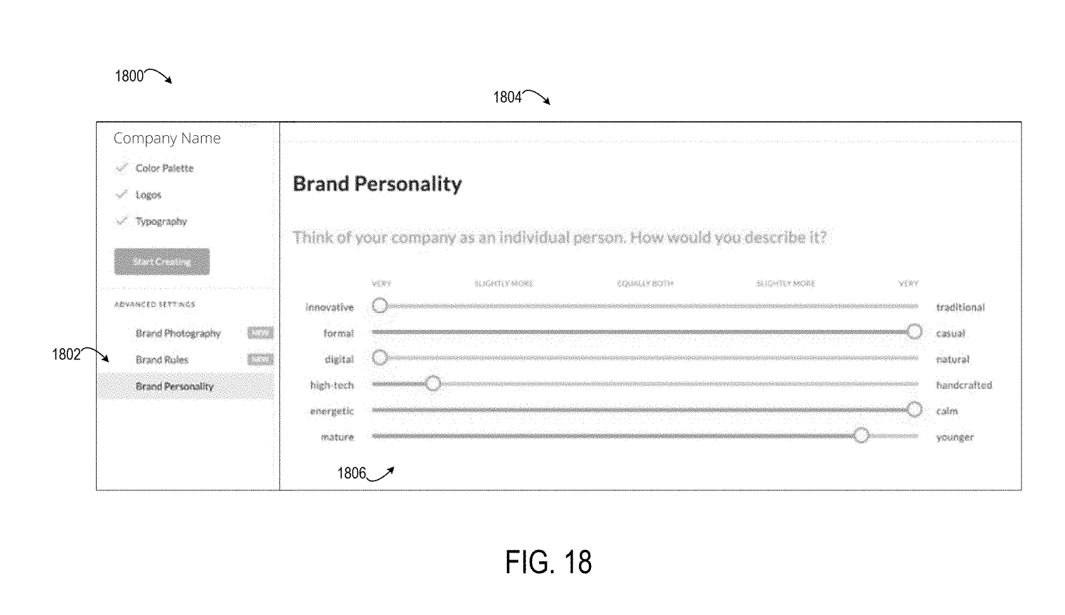

As discussed above with respect to FIG. 1, another example of a brand attribute is a personality attribute. FIG. 18 depicts an example of a profile-development interface 1800 for configuring one or more personality attributes. In this example, a personality configuration option 1802 has been selected. The profile-development interface 1800 can include, for example, a set of slider bars 1806, though other control elements could be used for selecting values with respect to different personality traits or dimensions. Each of the slider bars 1806 could represent a different dimension or trait used to update one or more personality attributes 124, and the two ends of a slide bar can represent opposing brand personality traits or dimensions. If the brand engine 104 receives input moving a marker along the slider bar, the brand engine 104 modifies a value of a corresponding personality attribute 124 represented by the slider bar. The position of the marker along the slider bar could, for example, strike a balance between two opposing personalities or lean towards one personality over an opposing personality.

For instance, the brand engine could access data describing each personality dimension, where the data maps values of the personality dimension to different sets of stylization options. A given personality dimension could have a first value corresponding to a first set of stylization options, a second value corresponding to a second set of stylization options, and one or more intermediate values corresponding to one or more subsets of the first and second sets of stylization options

In one example, a first personality dimension could have a range of values that represent a wholly “modern” personality at one end of the range and a wholly “traditional” personality at the other end of the range, with values within the range indicating different emphases on modern versus traditional. For instance, as a simplified example, if a “modern” personality corresponds to “more diversity in content” and a “traditional” personality corresponds to “less diversity in content,” a first slider position (i.e., “modern”) could indicate that a desirable layout has at least ten partitions, a second slider position 2 (i.e., halfway between “modern” and “traditional”) could indicate that a desirable layout has between four and ten partitions, and a third slider position (i.e., at “traditional”) could indicate that a desirable layout has at most two partitions. Other personality attributes 124 could have ranges of values representing, for example, edgy versus conservative, formal versus casual, aggressive versus passive, older versus younger, intellectual versus physical, outgoing versus introverted, energetic versus calm, high-tech versus handmade, complex versus simple, solid versus flexible, original versus newest, individual versus team-oriented, expensive versus affordable, etc.

Similarly, a second personality dimension could have a range of values that represent a wholly “funny” personality at one end of the range and a wholly “serious” personality at the other end of the range, with values within the range indicating different emphases on funny versus serious. The slider values for two or more personality dimensions of a personality attribute 124 can be used, in combination, to provide guidance to the design engine 108 with respect to a personality of output branded design content 130.

For instance, as a simplified example, if a “funny” personality corresponds to “more diversity in content” and a “serious” personality corresponds to “less diversity in content,” a first slider position (i.e., “funny”) could indicate that colors used in the branded design content must have RGB values greater than 200, a second slider position 2 (i.e., halfway between “funny” and “serious”) could indicate that colors used in the branded design content must have RGB values between 100 and 200, and a third slider position (i.e., at “serious”) could indicate that colors used in the branded design content must have RGB values between 10 and 100. To generate a personality attribute from the set of slider inputs across the first and second personality dimension, a “modern, funny” personality could result in the design engine selecting a layout with ten partitions having bright colors in each partition, a “traditional, funny” personality could result in the design engine selecting a layout with ten partitions having light colors in each partition, and a “½ modern ½ traditional, serious” could result in the design engine selecting a layout with four partitions having dark colors in each partition.

In some aspects, the brand engine 104 can identify values of various brand attributes based on user inputs to the profile-development interface 106 that specify the attribute value. Examples of these user inputs include text entered into input boxes, options selected from menu boxes, button clicks or radio button selections, color palette selections from a color grid, uploaded logos, photographs, and other images, audio, video, or other information relating to a brand. In one example, with respect to a font attribute, a profile-development interface 106 could present a list of available font types, font colors, font styles, etc. Selection inputs received with respect to the list (e.g., clicking items on the list, dragging and dropping items to a “whitelist” or “blacklist” section) could cause the brand engine 104 to update the font attributes with corresponding attribute values. In another example, with respect to a color attribute, a profile-development interface 106 could present a color palette available to a computing system (e.g., the user device 126, target devices for output branded design content 130, a digital graphic design computing system 100, etc.). Selection inputs received with respect to the presented color palette (e.g., clicking color patches, dragging and dropping color patches to a “whitelist” or “blacklist” section, etc.) could cause the brand engine 104 to update the color attributes with corresponding attribute values.

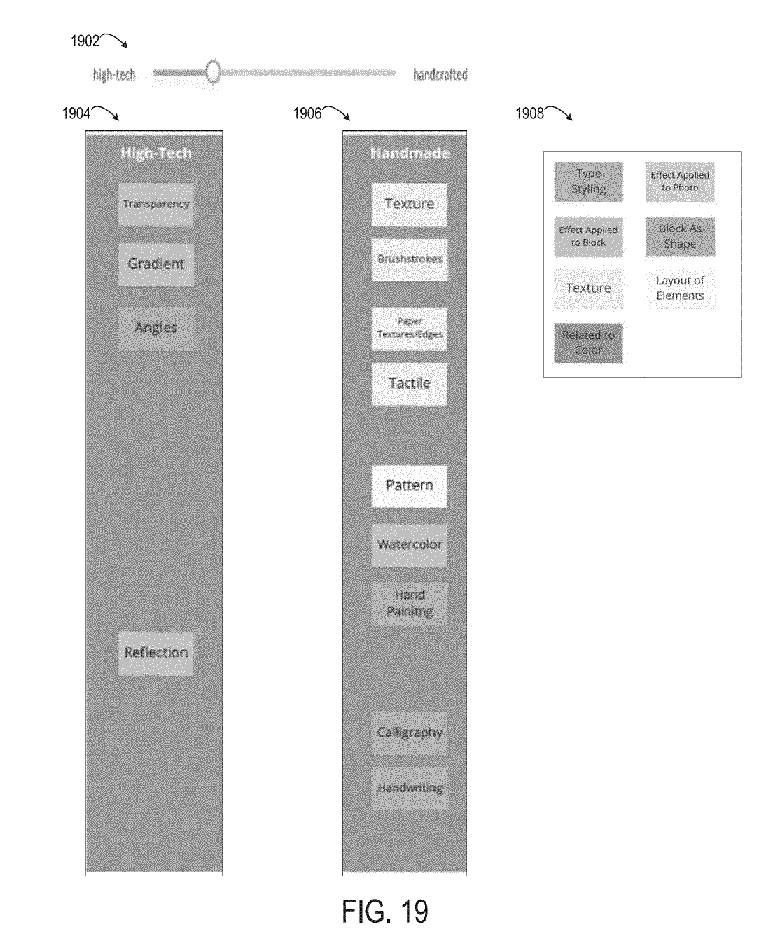

FIG. 19 includes block diagrams depicting a more complex set of stylization options corresponding to different values for a particular personality dimension. In this example, a “high-tech” personality represented by one end of a slider bar 1902 corresponds to a first set 1904 of stylization options (e.g., applying effects such as transparency, gradient textures, reflective lighting effects, angular block shapes). A “hand-crafted” personality represented by the other end of the slider bar 1902 corresponds to a second set 1906 of stylization options (e.g., applying effects such as high-texture color effects, colors that appear to have brush strokes, text with a hand-written or calligraphy-based appearance, etc.). The digital graphic design computing system 100 could access these different personalities (e.g., traits or dimensions) by access a data structure that maps certain personality types to values of a personality trait or dimension, and further maps these values of a personality trait or dimension to different sets of stylization options.

In FIG. 19, a legend 1908 identifies different categories of stylization options using different colors, with the colored blocks within the sets 1904 and 1906 specifying certain types of stylization options belonging to the different categories. Intermediate positions along the slider could include different combinations of the stylization options from the sets 1904 and 1906. For instance, a slider position halfway along the slider bar 1902 could include a complete union of the sets 1904 and 1906, a slider position closer to the “high-tech” personality could be all stylization options from the set 1904 supplemented with a subset of the stylization options from the set 1906, and a slider position closer to the “handcrafted” personality could be all stylization options from the set 1906 supplemented with a subset of the stylization options from the set 1904.

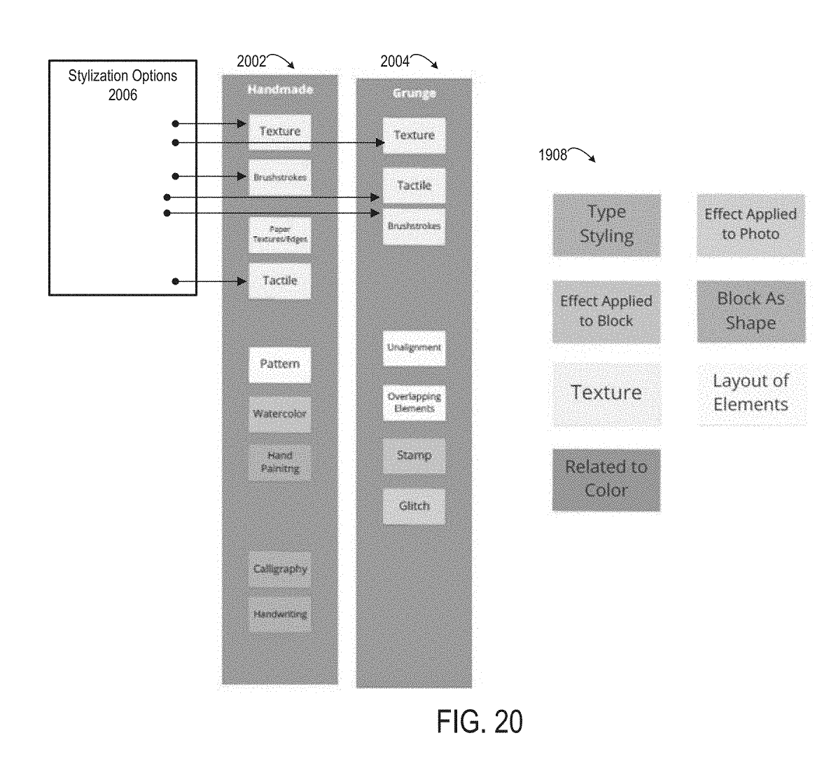

FIG. 20 includes block diagrams depicting a more complex set of stylization options corresponding to a combination of personality dimensions. In this example, a “handmade” personality, which could be indicated by a selected value for a first personality dimension, corresponds to a first set 2002 of stylization options. A “grunge” personality, which could be indicated by a selected value for a second personality dimension, corresponds to a second set 2004 of stylization options. In FIG. 20, a legend 1808 identifies different categories of stylization options using different colors, with the colored blocks within the sets 2002 and 2004 specifying certain types of stylization options belonging to the different categories. A set 2006 of stylization options corresponding to a combination of personality dimensions could include, at least, the stylization options that are common to both sets 2002 and 2004. In some aspects, the set 2006 of stylization options could also include some additional or all of the other stylization options included in either the set 2002 or the set 2004.

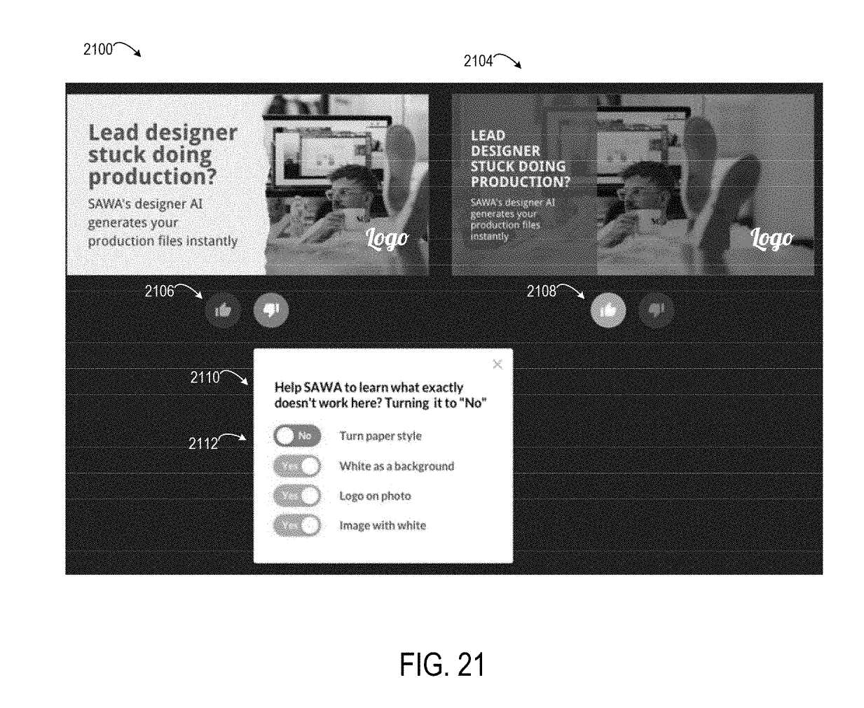

The branding engine 104 can be used to further refine one or more a personality attributes to remove certain stylization options from a set of stylization options. For instance, FIG. 21 depicts an example-based personality-refinement interface 2100, which is a type of profile-development interface. The example-based personality-refinement interface 2100 includes different previews 2102 and 2104 that apply subsets of different stylization options from a set of stylization options (e.g., the set 1906 from FIG. 21). The example-based personality-refinement interface 2100 can also include control elements 2106 and 2108 for providing positive or negative reactions to the previews 2102 and 2104. The example-based personality-refinement interface 2100 can also include a window 2110 configured for receiving more specific feedback on a preview having a negative reaction. The brand engine 104 can modify a set of stylization options to remove certain stylization options that resulted in the specific negative feedback indicated by input to the window 2110 (i.e., removing a stylization option that resulted in the “turn paper style” with the “no” option selected).

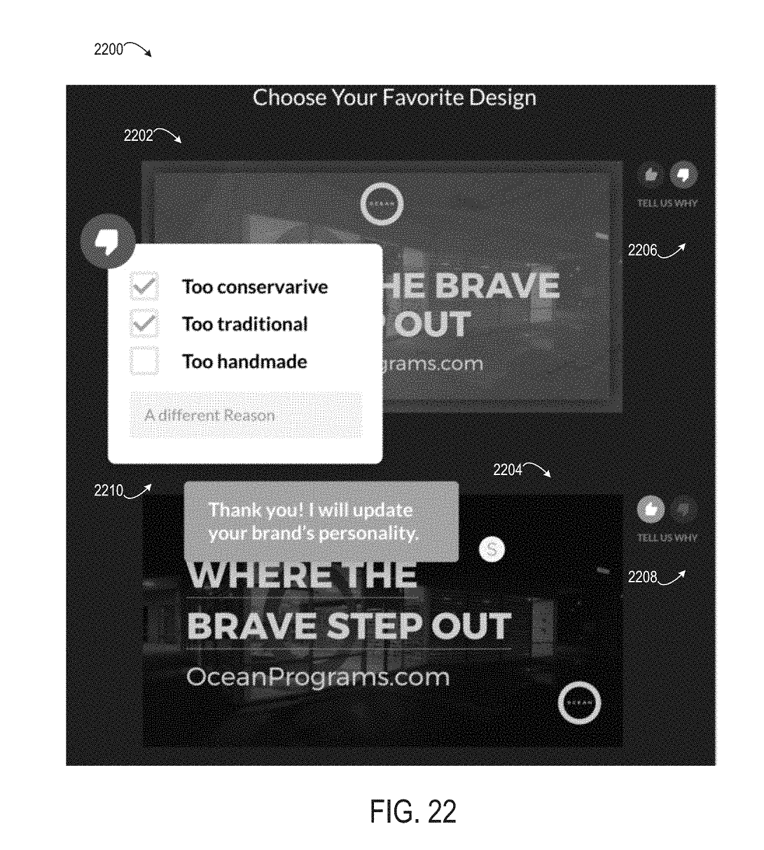

FIG. 22 depicts another example-based personality-refinement interface 2200, which is a type of profile-development interface. The example-based personality-refinement interface 2200 includes different previews 2202 and 2204 that apply subsets of different stylization options from a set of stylization options (e.g., the set 1906 from FIG. 20). The example-based personality-refinement interface 2200 can also include a control elements 2206 and 2208 for providing positive or negative reactions to the previews 2202 and 2204. The example-based personality-refinement interface 2200 can also include a window 2210 configured for receiving more specific feedback on a preview having a negative reaction. The brand engine 104 can modify a set of stylization options to remove certain stylization options that resulted in the specific negative feedback indicated by input to the window 2210. For instance, the brand engine 104 can remove a stylization option corresponding to a personality dimension indicated by the input (e.g., the selection of “too conservative”). In some cases, doing so can involve the brand engine 104 reducing a value for a personality dimension indicated by the window 2210 (i.e., moving the personality dimension value away from a “traditional” personality and toward a “modern” personality) and re-computing the set of stylization options based on the modified personality dimension value.

Different variations in sets of stylization options can be used. For instance, a brand personality style can include the stylization options for a particular type of personality or personality dimension. A style bundle can include stylization options having at least one commonality in a design style. For instance, a style bundle can include a complete union of the sets of stylization options for two or more personality types or dimensions. A style bundle can include stylization options having at least one commonality in a design style. For instance, a style bundle can include a refined union of the sets of stylization options for two or more personality types or dimensions, where the refined union includes more closely related stylization options. These different variations can be captured in the personality attributes of a brand profile.

In some aspects, the brand engine 104 and/or the design engine 108 can modify the personality attributes, based on user inputs, to implement variations in sets of stylization options. For instance, in a first time period, the digital design application 102 can use a first set of personality attribute values in a given brand profile to determine that the set of stylization options for a brand profile should be a stylization bundle (e.g., a union of stylization options for a “grunge” personality type and stylization options for a “handmade” personality type). In the first time period, the digital design application 102 can capture data regarding which types of stylization options are preferred by a given user or set of users. For instance, a user may consistently accept design content generated with certain stylization options in the stylization bundle and reject or modify design content generated with other stylization options in the stylization bundle. The digital design application 102 can modify the personality attribute values into a second set of attribute values that reflect stylization options preferred by the user or group of users. Thus, in the second time period, the digital design application 102 can use a second set of personality attribute values in the brand profile to determine that the set of stylization options for the brand profile should be a stylization family (e.g., a subset of the stylization options from a union of stylization options for a “grunge” personality type and stylization options for a “handmade” personality type).

Illustrative Example of Content Creation Process

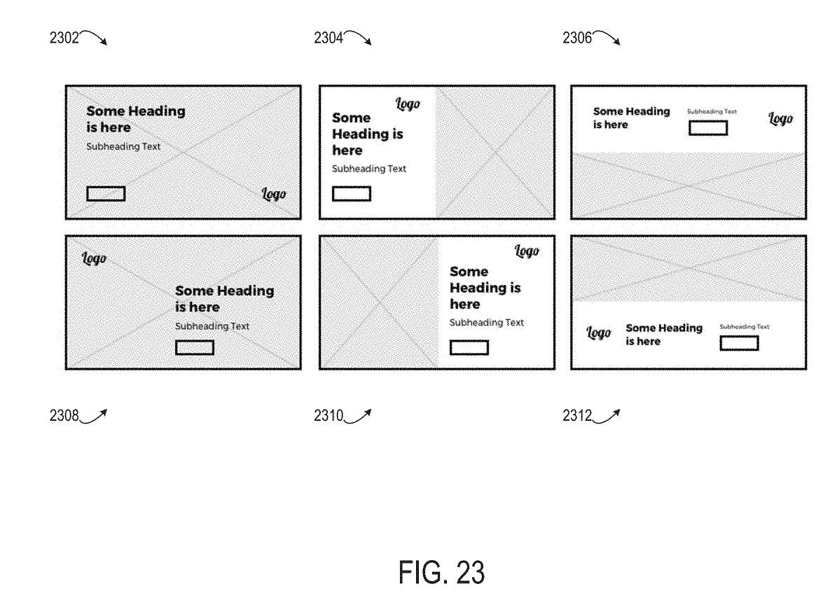

An illustrative example of the content creation process (e.g., the process 400 described above with respect to FIG. 4) is described herein with respect to FIGS. 23-28. FIG. 23 depicts an example of a set of wireframes 2302, 2304, 2306, 2308, 2310, and 2312 that could be used in a content-creation. Block 412 of the process 400 can involve constructing, selecting, or otherwise obtaining one or more of the wireframes 2302, 2304, 2306, 2308, 2310, and 2312. Each wireframe can have a layout with one or more blocks. In each of these examples, a layout includes for a graphic area (indicated by the X-shaped regions in FIG. 23) in which an input graphic is to be placed, for one or more text regions in which text is to be placed, and one or more logo regions in which a logo is to be placed. A block can be a portion of the layout that includes one or more of a graphic area, a text region, and a logo region. A text region could include, for example, a header region (e.g., the regions with “Some heading is here” in FIG. 23) and a subheader region (e.g., the regions with “Subheading text” in FIG. 23). A logo region (indicated by the “logo” region in FIG. 23) can be a graphic region positioned adjacent to or overlaid over one or more other regions.

In some aspects, the design engine 108 can receive a user input specifying a particular type of communication channel (e.g., social media feed, web content, brochure, etc.) to be used for generating a particular set of branded design content. In these aspects, the design engine 108 can select one or more wireframes that are suitable for the specified type of communication channel.

In some aspects, the design engine 108 can build a wireframe by grouping content elements based on one or more targeting parameters, arranging content element or groups of content elements based on one or more targeting parameters, or some combination thereof. A targeting parameter can include any rule, guidance, and/or data that controls or influences how the design engine 108 assigns content elements to groups, arranges content element or groups of content elements within a layout, or both.

One example of a targeting parameter is a user-specified purpose of the design content, such as whether the design content is intended to convey information (e.g., a “tell” purpose), present an aesthetically desirable scene (e.g., a “show” purpose), or convey information in an aesthetically desirable manner (e.g. a “show and tell” purpose). Grouping together certain content elements can increase the likelihood of the design achieving the intended purpose (e.g., conveying information by grouping together any text elements). Additionally or alternatively, selecting a certain position for certain content elements can increase the likelihood of the design achieving the intended purpose (e.g., conveying information by positioning text elements toward the top and left of the design or another position that draws a viewer's attention to the elements).

As a simplified example, a content elements for a design could include a header text element, a subheader text element, an input graphic, a text-based logo variant (e.g., stylized text from a logo), and an image-based logo variant (e.g., an icon from the logo). Assigning multiple elements to a particular content group can cause the design engine 108 to position those elements adjacent to one another in subsequent phases of a content-creation process. Positioning elements adjacent to each other can include inserting the elements next to the input graphic in a common layer of a layout, inserting different elements into the layout at different layers in positions that at least partially overlap, or some combination thereof.

If the targeting parameter is a “convey information” purpose, the design engine could group together, as a first content group, the header text element, the subheader text element, and the text-based logo variant (i.e., the elements that convey information), with the input graphic and the image-based logo variant being assigned to second and third content groups, respectively. Here, all of the elements in the first content group (e.g., the header text element, the subheader text element, and the text-based logo variant) will be positioned in same region of a layout (e.g., all elements in a given corner, all elements in the center, etc.) so that a viewer of the design is more likely to notice and retain information conveyed by the design. In another variation of this simplified example, if the targeting parameter is a “present desirable aesthetic” purpose, the design engine could group together, as a first content group, the input graphic and the image-based logo variant (i.e., the elements with a greater aesthetic impact), with the header text element and the subheader text element being assigned to second content group and the text-based logo variant being assigned to a third content group. Here, all of the elements in the first content group (e.g., the input graphic and the image-based logo variant) will be positioned in same region of a layout (e.g., all elements in a given corner, all elements in the center, etc.) so that a viewer of the design is more likely to experience a desired reaction. Additionally or alternatively, the design engine 108 can select positions within a layout for different content groups based on the intended purpose.

Another example of a targeting parameter is a type of communication channel via which the design is to be transmitted and/or presented. For instance, generating a design for a particular social media platform may cause the design engine 108 to perform grouping of content elements and/or arrangements of content elements that are suitable for that social media platform. (While social media platforms are used as an illustrative examples, similar processes can be used to group and/or arrange content elements for other types of communication channels, such as webpage, emails, direct mailings, notifications on mobile devices, etc.) The design engine 108 can evaluate the suitability of a design for a social media platform in any suitable manner. For example, a particular social media platform may include rules that specify where images are to be placed, where text is to be placed, etc. The design engine 108 can obtain these rules via user inputs, via communication with an application programming interface of the social media platform, or some combination thereof. The design engine 108 can group and/or arrange content elements in accordance with these rules. In another example, the design engine 108 can access rules or guidance indicating that certain types of groupings and/or arrangements are more effective for achieving a certain purpose for designs presented via the social media platform. The rules or guidance may be developed independently of any constraints imposed on the social media platform itself (e.g., created via a machine-learning model or expert system that evaluates the effectiveness of certain designs for certain purposes). The design engine 108 can perform groupings and/or arrangements of content elements in accordance with the rules or guidance.

One or more targeting parameter can be provided to the design engine 108 in any suitable manner. In some aspects, the digital design application 102 or other suitable software can allow an end user to specify certain targeting parameters (e.g., “if purpose=convey information, group text elements,” “if channel=social media, group graphical elements,” etc.). In additional or alternative aspects, targeting parameters can be obtained from other systems. For instance, the digital design application 102 can be used to retrieve layout constraints from social media platforms or other modes of presentation used by target devices 132. In additional or alternative aspects, a machine-learning model may be trained to classify various content elements as serving a certain purpose, and can be applied to the content elements in a content-creation process. For instance, if a user-specified purpose is “convey information,” a machine-learning model that is trained to score text, graphics, or both on their suitability for conveying information could be applied to the content elements. Content elements having higher “convey information” scores could be grouped together when building a wireframe.

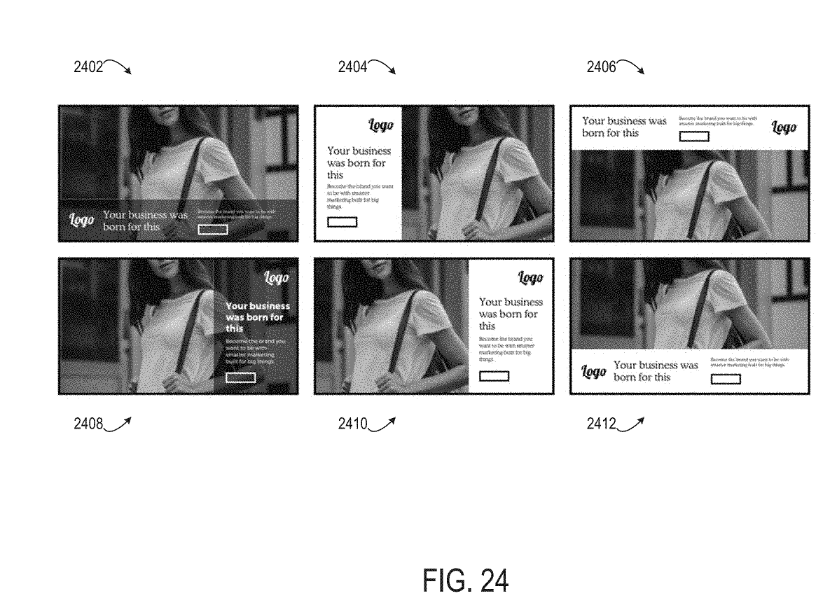

FIG. 24 depicts examples of wireframes that the design engine 108 can generate in an implementation of block 412. Each of the wireframes 2402, 2404, 2406, 2408, 2410, and 2412 can be generated by positioning an input graphic in a graphic region of a corresponding one of the wireframes 2302, 2304, 2306, 2308, 2310, and 2312 and positioning an input text element in a textual region of a corresponding one of the wireframes 2302, 2304, 2306, 2308, 2310, and 2312. A wireframe can be generated without regard to permissible text features and/or permissible visual features from a brand profile. The wireframe can be an interim design that is generated transparently to an end user. Generating the wireframe transparently to the user can include generating the wireframe within a process 400 that is triggered by a command to create branded design content, where the content-creation interface 110 that is used to trigger the content-creation process is not updated to display the wireframe.

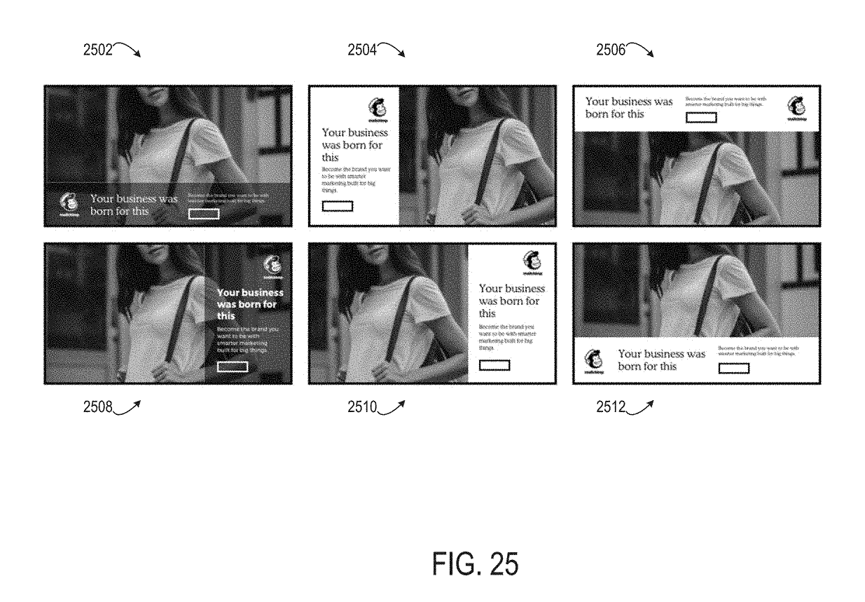

FIG. 25 depicts examples of branded design content that is generated in an implementation of block 412 by applying hard rules from the brand profile. Hard rules can include constraints on the branded design content, as indicated by the brand attributes of a brand profile that cannot be overridden by user-specified edits or stylization rules (e.g., guidance indicated by one or more personality attributes). For instance, the design engine 108 can generate examples of design content 2502, 2504, 2506, 2508, 2510, and 2512 that comply with hard rules of a brand profile (e.g., logo variations, typography constraints or other permissible text features, graphical constraints, etc.) by inserting a logo element that is compliant with the branded profile (e.g., one or more logo variants having a cropping or color information specified using the profile-development interface), modifying the input text from the examples in FIG. 23 to have permissible font characteristics, and performing any required modifications with respect to the input graphic.

In some aspects, each of the examples depicted in FIG. 25 can be an interim design that is generated transparently to an end user. Generating the interim design transparently to the user can include generating the interim design within a process 400 that is triggered by a command to create branded design content, where the content-creation interface 110 that is used to trigger the content-creation process is not updated to display the interim design.

In some aspects, the application of hard rules from a brand profile can be constrained based on the groupings and/or arrangements of content items used to build a wireframe. As a simplified example, a font attribute 116 could indicates that font sizes of 8-point to 36-point are permissible for a design, and a logo attribute 122 could indicate that permissible logo variants include a first logo variant that includes only graphics with no text and a second logo variant that includes only text with no graphics. However, the groupings and/or arrangements of content items may restrict which of the permissible fonts and logo variant should be used for a particular design. For instance, if a wireframe is built for a “show” purpose, where a text portion of the wireframe is much smaller than a graphics portion of the wireframe, then the design engine 108 could be constrained to using only font sizes that allow all of the text elements to fit within the text portion of the wireframe (e.g., font sizes of 8-point to 12-point rather than the full range of 8-point to 36-point). In another example, if a given social media platform for which the design is intended has a rule banning graphics-based logos, the design engine 108 could be constrained to using only the a second logo variant (i.e., the variant that includes only text with no graphics). But in another content-creation process with different targeting parameters (e.g., different purpose, different channel type, etc.), a different range of font sizes or different types of logo variants could be used by the design engine 108.

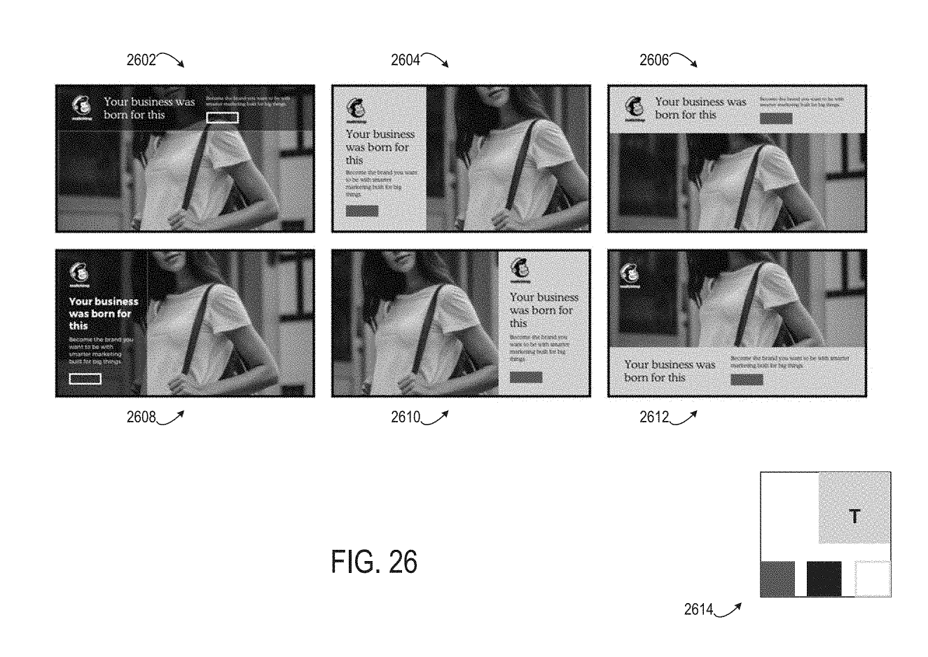

FIG. 26 depicts examples of branded design content that is generated in an implementation of block 412 by applying stylization guidance from the brand profile. Applying the stylization guidance can include modifying one or more colors in the design content based on one or more brand attributes, such as personality attributes. For instance, the design engine 108 can generate the examples of stylized design content 2602, 2604, 2606, 2608, 2610, and 2612 depicted in FIG. 26 by applying one or more of the permissible colors from the palette 2614 (e.g., colors identified in color attributes) in accordance with one or more personality attributes of a brand profile. Modifying content based on personality attributes can therefore allow the design engine 108 to generate content that is creative, while also being brand-compliant with respect to various hard rules described above.

Stylizing a design can include, for example, positioning an input graphic and/or an input text element adjacent to one or more permissible brand colors specified in a brand profile. Adjacent insertion could include, for example, inserting the brand color next to the input graphic or text element in a common layer of the layout, inserting the brand color and the input graphic or text in different layers of the layout at positions that at least partially overlap, etc.

In some aspects, another example of stylization guidance that can be applied to generate stylized design content is a brand volume parameter. Modifying content based on a brand volume can allow the design engine 108 to generate content that is creative, while also being brand-compliant with respect to various hard rules described above. A brand volume can indicate the prominence of input content (e.g., input text, an input graphic, etc.) obtained at block 404 of the process 400, the prominence of brand-specific content (e.g., applied colors from a color palette, logo content, other permissible on-brand graphics identified in the brand profile, etc.) identified at one or more of block 406-410 in the process 400, or some combination thereof. The prominence of input content or brand-specific content can be modified based on a goal of a particular branded design content item. For instance, if the design engine 108 determines (e.g., from a user-specified configuration option) that the branded design content is intended for informational purposes that are at least somewhat independent of the brand, the design engine 108 can decrease a brand volume. Decreasing a brand volume can increase the likelihood of a viewer of the branded design content recalling the input content as compared to the likelihood of the viewer of the branded design content recalling the brand-specific content. Conversely, if the design engine 108 determines (e.g., from a user-specified configuration option) that the branded design content is intended for branding purposes (e.g., developing brand awareness or affinity), the design engine 108 can increase a brand volume. Increasing a brand volume can increase the likelihood of a viewer of the branded design content recalling the brand-specific content as compared to the likelihood of the viewer of the branded design content recalling the input content.

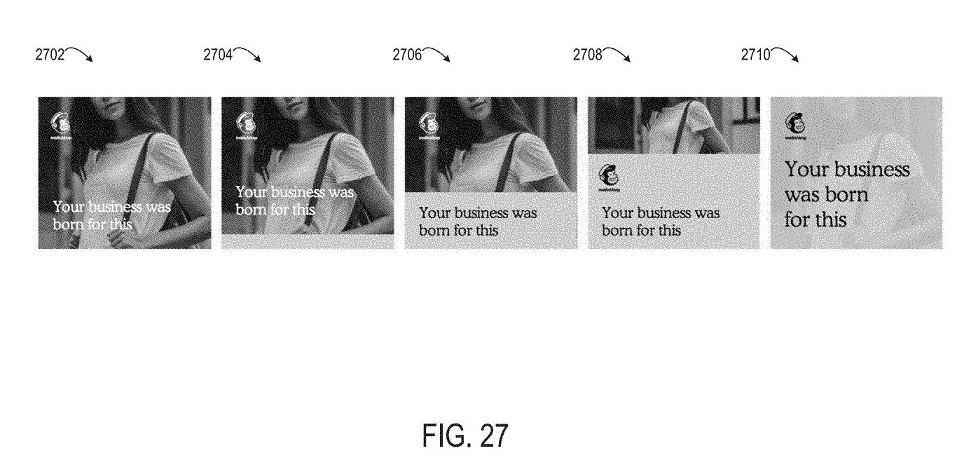

FIG. 27 depicts examples of branded design content that are generated based on different brand volumes. For instance, the branded design content item 2702 is generated using a low brand volume, such that a majority of the visible content in the branded design content item 2702 is input content and the only brand-specific content is a logo. The branded design content item 2704 is generated using a slightly higher brand volume, such that a majority of the visible content in the branded design content item 2704 is input content, with an increased amount of brand-specific content (i.e., the logo and a color from the brand's color palette). The branded design content item 2704 is generated using a medium brand volume, such that the branded design content item 2704 is evenly or near-evenly divided between input content and brand-specific content (i.e., the logo and a larger area having a color from the brand's color palette). The branded design content item 2708 is generated using a high brand volume, such that a majority of the visible content in the branded design content item 2708 is brand-specific input content, with a decreased amount of input content. The branded design content item 2710 is generated using a maximum brand volume, such that a large majority of the visible content in the branded design content item 2710 is brand-specific input content.

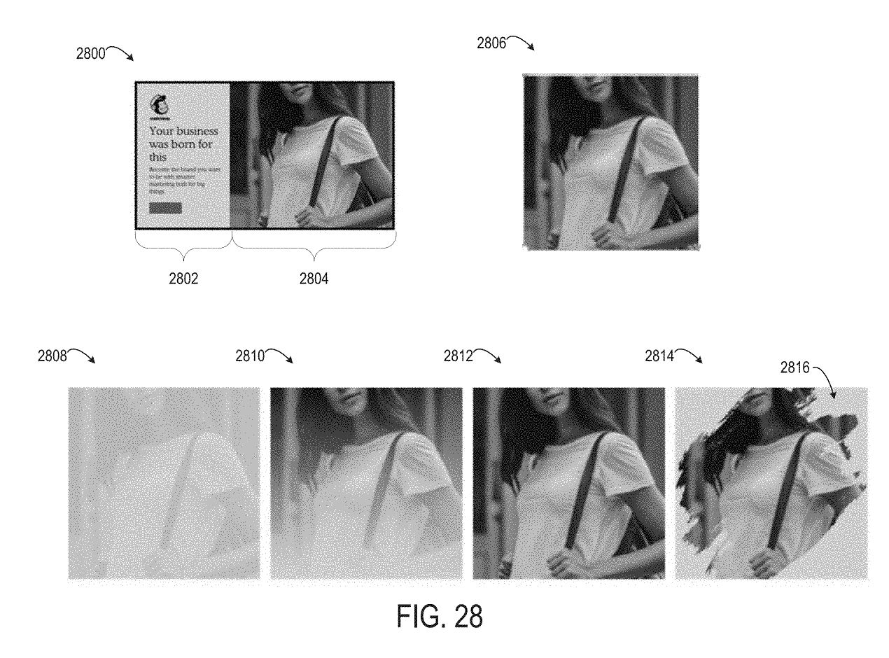

In some aspects, the design engine 108 can use one or more personality attributes 124 to stylize one or more blocks within a wireframe. A block can include a section within a wireframe (e.g., a particular partition within a layout) to which a given stylization operation is applied. For example, in FIG. 28, a wireframe 2800 includes a first block 2802 having a first set of one or more content elements (e.g., a logo, header text, and subheader text) and a second block 2804 having a second set of one or more content elements (e.g., the image 2806).

The design engine 108 can determine that the block 2804 includes an image 2806. To stylize the block 2804, the design engine 108 can access a personality attribute 124 to identify which stylization options are available for the brand profile being used. As a simplified example, the stylization options could include layout-based stylizations that impact the arrangement of content elements within a block (e.g., “use overlapping elements,” “minimize whitespace,” etc.), text-based stylizations for applying effects to text within a block (e.g., “use calligraphy-based font styles”), and graphics-based stylizations for applying visual effects to graphics within a block (e.g., “borders with a brushstroke appearance”).

The design engine 108 can further determine which of the available stylization options are applicable to a particular block. For instance, in FIG. 28, the design engine 108 can determine that the layout-based stylizations and the graphics-based stylizations are applicable, since the block 2804 includes an image, and that the text-based stylizations are not applicable, since the block 2804 lacks any text elements.

The design engine 108 can apply one or more stylization options that are available in a brand profile and applicable to a given block. For instance, in FIG. 28, the design engine 108 could apply a “minimize whitespace” stylization by determining that the image 2806 is the only element within the block 2804 and therefore modifying the height and width of the image 2806 to occupy the entirety of the block 2804. Each of the resulting stylized blocks 2808, 2810, 2812, and 2814 include this stylization. The design engine 108 could also apply, for example, a “borders with a brushstroke appearance” stylization to the image 2806 by generating a border 2816 and overlaying the border on the image 2806 to generate the stylized block 2814.

The design engine 108 can perform a similar stylization process with respect to each block in a wireframe. For instance, in FIG. 28, the design engine 108 can determine that the layout-based stylizations and the text-based stylizations are applicable to the block 2802. The design engine 108 can apply one or more of the applicable layout-based stylizations to the set of content elements in the block 2802, and can apply text-based stylizations to the text elements in the block 2802.

The example depicted in FIG. 28 involving a relatively small number of content elements and stylizations is used for illustrative purposes. In various aspects, any suitable number of stylizations can be applied to any suitable number of content elements within a block.

In some aspects, the design engine 108 can stylize a block in accordance with one or more personality attributes 124 in a manner that is constrained by other attributes of the brand profile, other configuration parameters in the content-creation process, or some combination thereof. In one example involves brand attributes, the stylizations performed in FIG. 28 could be constrained based on, for example, a color attribute 118 specifying that only a certain set of colors (e.g., yellow, teal, black and white) is permitted to be used in a design and that only a graphical attribute 120 specifying that only a subset of those colors (e.g., yellow) is permitted to be applied to input graphics. Thus, each of the stylized blocks 2808, 2810, 2812, and 2814 uses a yellow color in FIG. 28.

Similarly, stylization applied to the block 2802 can be constrained by other parameters. In one example, the design engine 108 can determine that a text-based stylization is incompatible with one or more font attributes and therefore omit that text-based stylization. As an example, a brand profile could have a personality attribute values that causes a “calligraphy” style of text to be an available stylization option. However, the font attributes 116 may only specify fonts that lack any corresponding “calligraphy” style (e.g., by specifying that only Courier fonts may be used). In this example, the design engine 108 is prevented from applying the available text-based stylization.

In another example involving a different configuration parameter, a targeting parameter used for grouping or arranging content items may prevent an available stylization option from being applied. As a simplified example, a particular grouping and arrangement of content items, which is used for a user-specified purpose or a type of communication channel, may cause multiple text elements to be grouped together and positioned in a corner of a block, thereby creating a large area of whitespace in an opposite corner of the block. In this example, a layout-based stylization indicated by a personality attribute may involve evenly distributing content elements in a block such that each portion of whitespace in a block is minimized. Here, the design engine 108 can override the layout-based stylization based on the previously generated grouping and arrangement and grouping of content items.

In another example involving a different configuration parameter, a variation in a brand volume parameter can cause the design engine 108 to select certain stylizations. For instance, different stylization options could result in different stylized blocks 2808, 2810, 2812, and 2814. Increasing a brand volume could cause stylizations that utilize a greater degree of brand-specific content to be used by the design engine 108, e.g., by selecting stylization options that result in stylized blocks 2808 or 2812 (where the brand-specific yellow color predominates) rather than stylization options that result in stylized blocks 2810 or 2814 (where the brand-specific yellow color is less dominate with respect to the user-provided image 2806). Additionally or alternatively, a variation in a brand volume parameter can cause the design engine 108 to modify how the stylizations are performed. For instance, if a “borders with a brushstroke appearance” stylization is used to generate the stylized block 2814, a larger value of the brand volume parameter can cause the design engine 108 to increase the size of the border 2816, and a smaller value of the brand volume parameter can cause the design engine 108 to decrease the size of the border 2816.

In some aspects, one or more of the examples depicted in the figures above can be initial branded design content that is generated transparently to an end user. For instance, prior to outputting branded design content (e.g., updating the content-creation interface 110 to preview the branded design content), the design engine 108 can apply a design-quality model to the initial branded design content. The design engine 108 can modify a decision made in one or more operations of a content-creation process (e.g., select different content groupings or arrangements to build a different wireframe, choose different text or visual features permitted by the brand attributes, select a different stylization option, etc.).

In some aspects, a design-quality model is a neural network is an expert system. An expert system is a software engine that applies one or more rules that emulate human decision-making. For instance, such an expert system can include rules that are based on the brand profile. The expert system could analyze branded design content to determine whether one or more constraints imposed by font attributes, color attributes, etc. have been violated. As a simplified example, one or more brand attributes could indicate that text of a certain should not be placed against a particular background color. When stylizing a block having input text that is positioned over a user-provided input graphic, the design engine 108 could avoid adding the background color to the block based on the prohibited font-color/background-color combination. However, the user-provided input graphic, on which the input text is placed, could itself include the particular background color. Thus, initial branded design content generated by a content-creation process could violate a constraint in the brand profile even if the design engine 108 used the brand profile to constrain the creation of the initial branded design content. The design-quality model, by checking the initial branded design content for violations of this constraint, can thereby cause the design engine 108 to perform a modified iteration of the content-creation process to resolve the violation (e.g., by building a wireframe that does not place the input text over the input graphic).

Additionally or alternatively, an expert system can include rules that are independent of the brand profile. For instance, the design engine 108 could apply an expert system to determine whether initial branded design content complies with one or more guidelines governing the aesthetic quality of a design (e.g., avoiding certain color schemes that connote anger or other negative emotions). An initial branded design content could comply with any constraints of a brand profile and still violate such a guideline (e.g., applying a red overlay to imagery). The design engine 108 can perform a modified iteration of the content-creation process to resolve the violation (e.g., selecting a different color for the overlay that is permitted by the brand profile).

In some aspects, violation of any rule in a design-quality model can cause the cause the design engine 108 to perform a modified iteration of the content-creation process. For instance, if an expert system includes ten rules, an initial branded design content could comply with all but one of the rules and still trigger a modified iteration of the content-creation process to correct the violation associated with the single rule. Furthermore, a subsequent iteration of the content-creation process can be modified based on which rules were violated. For instance, a first rule could be violated due to text being overlaid on an image when constructing a wireframe, and a second rule could be violated due to a particular background color being overlaid on the image during a stylization process. In this example, the design engine 108 can modify a subsequent iteration of the content-creation process. The modifications can include building a different wireframe, which could resolve the violation of the first rule, and choosing a different background color in the stylization process, which could resolve the violation of the second rule.

The examples of particular rule violations and remedial actions described above are provided for illustrative purposes only. Other rule violation may be detected and other accompanying remedial actions may be performed by the design engine.

In additional or alternative aspects, a design-quality model is a neural network or other machine learning model that has been trained, using suitable training examples, to recognize compliance with one or more design rules and/or deviation from one or more design rules. In some aspects, applying the trained design-quality model can cause block 412 of the content creation process to have multiple iterations. For instance, a first iteration can involve generating initial branded design content. The initial branded design content can include an initial layout provided by a wireframe that is constructed in the first iteration.

If a quality score generated by applying the trained design-quality model to the initial branded design content is below a threshold quality score, the design engine 108 can perform one or more remedial actions. Examples of remedial actions include selecting a different layout, building a different wireframe having a different layout (e.g., a different one of the wireframes depicted in FIG. 23), modifying one or more stylizations applied to the branded design content (e.g., modifying a color selected in FIG. 27), modifying a brand volume, modifying a text feature while remaining compliant with constraints of the brand profile, modifying a visual feature while remaining compliant with constraints of the brand profile, etc. A second iteration can be performed using the remedial action. If a quality score generated by applying the trained design-quality model to the branded design content in the second iteration is below a threshold quality score, the design engine 108 can again perform one or more remedial actions and continue iterating. If a quality score generated by applying the trained design-quality model to the branded design content in the second iteration is above a threshold quality score, the design engine 108 can output the branded design content at block 414 of the process 400.

In additional or alternative aspects, the design engine 108 can create multiple branded content designs from a set of wireframes suitable for a given communication channel. The design engine 108 can apply the trained design-quality model to each branded content design and thereby generate a set of quality scores for the branded content designs, respectively. The design engine 108 can select, as the output branded design content, a branded content design having a quality score indicating a sufficiently desirable quality (e.g., a branded content design having a highest score).

In additional or alternative aspects, the design-quality model can be trained to identify contributors to a quality score. For example, the design-quality model can output a set of individual quality scores based on different visual features of an initial branded design content item. An overall quality score can be computed from a combination of these quality scores (e.g., a sum or weighted sum of the individual quality scores). If the overall quality score is less than a threshold quality score, the design engine 108 can identify which of the individual quality scores are lower than other individual quality scores (e.g., by sorting the individual quality scores or weighted quality scores in order of magnitude). The design engine 108 can select a remedial action based on which of the individual quality scores is lowest or sufficiently low. For instance, if an individual quality score for a color scheme is the lowest, the design engine 108 can select a remedial action that involves selecting one or more different colors from a set of colors that are permissible under the brand profile.

Examples of Brand Attributes

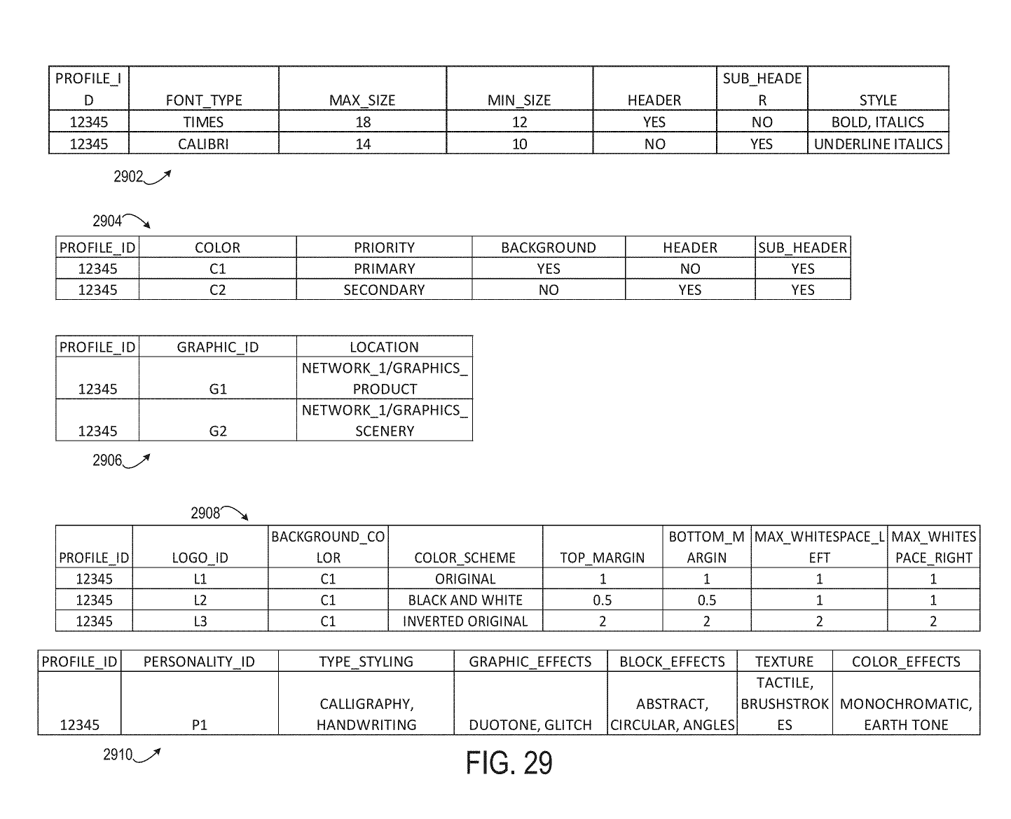

FIG. 29 depicts examples of brand attributes that could be included in a brand profile. For illustrative purposes, FIG. 29 depicts a set of brand attributes as tables of a relational database. Other data structures, however, can be used.

The brand attributes depicted in FIG. 29 include font attributes 2902. The font attributes 2902 can be examples of the font attributes 116 depicted in FIG. 1. In this example, the font attributes include a profile identifier (which can be a key for a record), a font type, a field indicating a maximum permissible size for the font, a field indicating a minimum permissible size for the font, fields indicating whether the color can be used in headers and/or subheaders, and a field indicating permissible font styles. In some aspects, one or more of the operations described above with respect to FIGS. 1 and 12 can cause fields in a particular one of the font attributes 2902 to be modified.

The brand attributes depicted in FIG. 29 also include color attributes 2904. The color attributes 2904 can be examples of the color attributes 118 depicted in FIG. 1. In this example, the color attributes include a profile identifier (which can be a key for a record), a color identifier, a priority field indicating the color's priority (e.g., “primary” or “secondary”), and fields indicating whether the color can be used in backgrounds, headers, and/or subheaders. In some aspects, one or more of the operations described above with respect to FIGS. 1 and 9-11 can cause fields in a particular one of the color attributes 2904 to be modified.

The brand attributes depicted in FIG. 29 also include graphical attributes 2906. The graphical attributes 2906 can be examples of the graphical attributes 120 depicted in FIG. 1. In this example, the graphical attributes include a profile identifier (which can be a key for a record), an identifier for a particular graphic, and a location of a network share or memory address at which the graphic can be found. In some aspects, one or more of the operations described above with respect to, for example, FIG. 1 can cause fields in a particular one of the graphical attributes 2906 to be modified.

The brand attributes depicted in FIG. 29 also include logo attributes 2908. The logo attributes 2908 can be examples of the logo attributes 122 depicted in FIG. 1. In this example, the logo attributes include a profile identifier (which can be a key for a record), an identifier for a particular logo variant, a field identifying one or more permissible background colors, a field indicating whether the logo variant includes an “original” color scheme or a system-generated modification (e.g., a conversion of the original color scheme to black-and-white), and fields indicating permissible margins of white space along the sides of the logo. In some aspects, one or more of the operations described above with respect to FIGS. 1, 11, and 13-17 can cause fields in a particular one of the font attributes 2902 to be modified.

The brand attributes depicted in FIG. 29 also include personality attributes 2910. The personality attributes 2910 can be examples of the personality attributes 124 depicted in FIG. 1. In this example, the personality attributes can include a profile identifier (which can be a key for a record), an identifier for a particular personality type, a field indicating stylizations that may be applied to typefaces in accordance with the personality type, a field indicating stylizations that may be applied to graphics in accordance with the personality type, a field indicating stylizations that may be applied to object shapes or blocks in accordance with the personality type, a field indicating texture-based stylizations that may be applied to colors in accordance with the personality type, and a field indicating color effects that may be applied in accordance with the personality type. In some aspects, the values of the different fields can be updated based on the stylization options that are identified or selected using the brand engine 104. For instance, one or more of the operations described above with respect to FIGS. 1 and 18-23 can cause fields in a particular one of the personality attributes 2910 to be modified to reflect a set of stylization options.

In the example depicted in FIG. 29, a brand profile directly specifies permissible text features and visual features. Thus, the brand profiles depicted in FIG. 29 indirectly indicate impermissible content characteristics. But other examples are possible. For instance, brand attributes in a brand profile may explicitly specify certain brand attribute values that must be excluded from certain branded design content.

Analytics-Based Development or Refinement of Brand Profile

In some aspects, the brand engine 104, the design engine 108, or another engine of the digital design application 102 can modify one or more attributes in a brand profile based on analytics for content created with the digital design application 102. For instance, any analytics tool, which could be executed on the digital graphic design computing system 100 or another computing system, can gather, generate, or otherwise obtain analytics regarding the performance of various content items created with the digital design application 102. The analytics could indicate that certain features (e.g., font types, color schemes, stylization options, etc.) are associated with increased performance (e.g., click-throughs, conversions, etc.). The brand engine 104 can modify various attribute values in the brand profile based on the analytics. In some aspects, the brand engine 104 can modify hard rules (e.g., font attribute, color attributes, graphical attributes, logo attributes) and thereby constrain design choices implemented by the design engine 108 such that subsequent designs have one or more features associated with a desired performance. In additional or alternative aspects, the brand engine 104 can modify stylization guidance (e.g., brand volume, personality attribute values) or other parameters (e.g., targeting parameters used to build wireframes) and thereby guide design choices implemented by the design engine 108 such that subsequent designs have one or more features associated with a desired performance.

Examples of Features

There follows a list of numbered features labelled F1 . . . FN defining particular aspects of the present disclosure. Descriptions of these features are found above with respect to FIGS. 1-29. Where a numbered feature refers to an earlier numbered feature then those features may be considered in combination.

F1. A digital graphic design computing system comprising:
a network interface device configured for establishing one or more communications sessions with a user device via one or more data networks;
a non-transitory computer-readable medium storing a profile repository having brand profiles for controlling digital design content creation; and
processing hardware that is communicatively coupled to the non-transitory computer-readable medium and the network interface device and that is configured for performing operations that include:
   (i) creating a brand profile within the profile repository, wherein creating the brand profile comprises:
      (a) providing a profile-development interface to the user device via the one or more communication sessions,
      (b) identifying, based on input received via the profile-development interface, values for brand attributes that constrain creation of branded design content, the brand attributes comprising one or more of a font attribute, a color attribute indicating permissible colors for inclusion in the branded design content, a graphical attribute indicating permissible graphical content for inclusion in the branded design content, and a personality attribute indicating stylization options for the branded design content,
      (c) updating the brand profile to include the identified values for the brand attributes, and
      (d) modifying the profile repository in the non-transitory computer-readable medium to include the brand profile as updated with the identified values for the brand attributes; and
   (ii) generating the branded design content, wherein creating the branded design content comprises:
      (a) providing a content-creation interface to the user device via the one or more communication sessions,
      (b) obtaining, based on input received via the content-creation interface, an input graphic and an input text element;
      (c) identifying, from the brand profile as stored in the profile repository, one or more of a permissible text feature for the input text element and a permissible visual feature for displaying the input graphic,
      (d) applying the one or more of the permissible text features to the input text element and the permissible visual feature to the input graphic,
      (e) creating the branded design content by positioning, within a layout, the input text element and the input graphic having the one or more of the permissible text feature and the permissible visual feature applied,
      (f) updating the content-creation interface to display the branded design content, and
      (g) causing the network interface device to provide the user device with access to the updated content-creation interface.

F2. The digital graphic design computing system of F1, wherein the processing hardware is configured for identifying the values of the brand attributes by performing operations comprising:
identifying, from the input received via the profile-development interface, a brand exemplar having a design content example with a text example and a graphic example;
performing an analysis of the brand exemplar that identifies (i) a set of font values for the font attribute included within the brand exemplar and (ii) a set of color values for the color attribute included within the brand exemplar;
updating the profile-development interface to include one or more control elements configured for receiving (i) font-selection input selecting at least some font values from the set of font values and (ii) color-selection input selecting at least some color values from the set of color values;
receiving the font-selection input and the color-selection input via the updated profile-development interface;
modifying the font attribute of the brand profile to include the at least some font values indicated by the font-selection input; and
modifying the color attribute of the brand profile to include the at least some color values indicated by the color-selection input.

F3. The digital graphic design computing system of F1, wherein the processing hardware is further configured for generating the branded design content by performing at least a first iteration in which initial branded design content is modified without updating the content-creation interface to display the initial branded design content and a second iteration in which the content-creation interface is updated to display the branded design content,

wherein the first iteration comprises:
identifying, from the brand profile, an initial permissible text feature for the input text element and an initial permissible visual feature for displaying the input graphic,
retrieving an initial layout for the branded design content,
applying the initial permissible text feature to the input text element and positioning the input text element, with the initial permissible text feature, within the initial layout,
applying the initial permissible visual feature to the input graphic and positioning the input graphic, with the initial permissible visual feature, within the initial layout,
applying a design-quality model to the initial branded design content, wherein the initial branded design content has both (i) the input text element with the initial permissible text feature and (ii) the input graphic with the initial permissible visual feature positioned within the initial layout, and
determining, by applying the design-quality model to the initial branded design content, that the initial branded design content should be modified,

wherein the second iteration comprises performing at least one of:
selecting a different layout instead of the initial layout,
selecting the permissible text feature instead of the initial permissible text feature, and
selecting the permissible visual feature instead of the initial permissible visual feature.

F4. A method in which one or more processing devices perform operations comprising:
providing, to a user device, a content-creation interface having control elements for identifying one or more input graphics and one or more input text elements to be included in branded design content;
receiving, via the content-creation interface, input comprising an input text element, an input graphic, and a selection of a command to create the branded design content;
creating, responsive to receiving the selection of the command, the branded design content by executing a content-creation process comprising:
accessing a brand profile from a non-transitory computer-readable medium storing a brand profile repository;
identifying, from the brand profile, a permissible text feature for the input text element and a permissible visual feature for displaying the input graphic,
retrieving a layout for the branded design content,
applying the permissible text feature to the input text element and positioning the input text element, with the applied permissible text feature, within the layout,
applying the permissible visual feature to the input graphic and positioning the input graphic, with the applied permissible visual feature, within the layout, and
outputting the branded design content having the layout in which (i) the input text element with the applied permissible text feature and (ii) the input graphic with the applied permissible visual feature are positioned; and
updating the content-creation interface to display the branded design content.

F5. The method of F4, wherein applying the permissible visual feature comprises positioning the input graphic adjacent to a brand color specified in the brand profile.

F6. The method of F5, wherein positioning the input graphic adjacent to the brand color specified in the brand profile comprises one or more of (i) inserting the brand color next to the input graphic in a common layer of the layout and (ii) inserting the brand color and the input graphic in different layers, respectively, of the layout.

F7. The method of F4, wherein applying the permissible visual feature comprises restricting a modification of a font attribute of the input text element to a permissible font attribute value identified in the brand profile.

F8. The method of F4, wherein the content-creation process comprises:
a first iteration in which initial branded design content is modified without updating the content-creation interface to display the initial branded design content; and
a second iteration in which the branded design content is outputted and the content-creation interface is updated to display the branded design content.

F9. The method of F8, wherein the first iteration comprises:
identifying, from the brand profile, an initial permissible text feature for the input text element and an initial permissible visual feature for displaying the input graphic,
retrieving an initial layout for the branded design content,
applying the initial permissible text feature to the input text element and positioning the input text element, with the initial permissible text feature, within the initial layout,
applying the initial permissible visual feature to the input graphic and positioning the input graphic, with the initial permissible visual feature, within the initial layout,
applying a design-quality model to the initial branded design content, wherein the initial branded design content has both (i) the input text element with the initial permissible text feature and (ii) the input graphic with the initial permissible visual feature positioned within the initial layout, and
determining, from the design-quality model, that the initial branded design content should be modified; and

wherein the second iteration comprises performing at least one of:
selecting the layout instead of the initial layout,
selecting the permissible text feature instead of the initial permissible text feature, and
selecting the permissible visual feature instead of the initial permissible visual feature.

F10. The method of F4, wherein the control elements comprise one or more of:

a text field configured for receiving typing input that specifies the input text element, and

an upload element configured for (i) receiving an input identifying a memory location in which a file containing the input text element is stored and (ii) instructing the one or more processing devices to retrieve the file from the memory location.

F11. The method of F4, wherein the control elements comprise one or more of:
an upload element configured for (i) receiving a text input identifying a memory location in which a file containing the input text element is stored and (ii) instructing the one or more processing devices to retrieve the file from the memory location; and
a drag-and-drop field configuring for receiving a drag-and-drop input moving a visual representation of the input graphic over the content-creation interface, wherein the one or more processing devices retrieve the input graphic responsive to receiving the drag-and-drop input.

F12. The method of F4, the operations further comprising:
receiving, via the updated content-creation interface, an edit input identifying a modification to the branded design content;
determining that the modification violates one or more of (i) a constraint on permissible text features specified by the brand profile and (ii) a constraint on permissible visual features specified by the brand profile; and
rejecting the modification specified by the edit input.

F13. The method of F4, wherein the content-creation process further comprises:
a first stage comprising:
   accessing a set of content elements comprising:
   input text elements that include the input text element indicated by the input received via the content-creation interface,
   the input graphic, and
   a logo element,
   assigning, based on a targeting parameter, the content elements into a first group and a second group, wherein no content element is included in both the first group and the second group,
   positioning, based on the targeting parameter, the first group in a first block of a layout and the second group in a second block of the layout;
a second stage that comprises applying the permissible text features to the input text elements, wherein applying the permissible text features is constrained by (i) the permissible text and visual features and (ii) the positioning corresponding to the targeting parameter;
a third stage comprising:
   accessing one or more personality attributes that define a set of stylization options associated with the brand profile;
   determining that a first subset of the stylization options is applicable the first group in the first block and applying, to the first block, a first stylization that includes the first subset of the stylization options, wherein the first stylization is constrained by (i) the permissible text feature, (ii) the permissible visual feature, and (ii) the positioning of the first group performed based on the targeting parameter; and
   determining that a second subset of the stylization options is applicable the second group in the second block and applying, to the second block, a second stylization that includes the second subset of the stylization options, wherein the second stylization is constrained by (i) the permissible text feature, (ii) the permissible visual feature, and (ii) the positioning of the second group performed based on the targeting parameter.

F14. The method of F13, wherein the content-creation process further comprises:
identifying a value of a brand volume parameter, the brand volume parameter indicating a first prominence for input content and a second prominence for brand-specific content, the input comprising the input text elements and the input graphics, the brand-specific content comprising one or more of (i) the logo element identified in the brand profile, (b) a permissible color identified in the brand profile, and (iii) a permissible graphic identified in the brand profile, wherein each of the first and second stylizations is further constrained by the brand volume parameter having the identified value.

F15. The method of F13, wherein the content-creation process further comprises:
applying a design-quality model to an initial branded design content generated by a first iteration of the content-creation process, the first iteration comprising the first stage, the second stage, and the third stage;
determining, from the design-quality model, that the initial branded design content should be modified;
performing, based on determining that the initial branded design content should be modified, a second iteration comprising the first stage, the second stage, and the third stage, wherein one or more of the first stage, the second stage, and the third stage is performed differently in the second iteration as compared to the first iteration; and

outputting the branded design content from the second iteration.

F16. The method of F15, wherein determining that the initial branded design content should be modified comprises identifying, from the design-quality model, a violation of a constraint imposed by one or more of (i) the brand profile and (ii) a design rule independent of the brand profile, wherein modifying the design comprises modifying a feature of the initial branded design content that caused the violation of the constraint.

F17. The method of F16, further comprising determining that one of the first stage, the second stage, or the third stage caused the initial branded design to include the feature, wherein the second iteration comprises modifying an operation performed by the one of the first stage, the second stage, or the third stage.

F18. The method of F4, further comprising:
presenting the branded design content design in the content-creation interface;
accessing a content-editing tool having a set of options for modifying the branded design content;
determining that one or more of the options violates a constraint from the brand profile;
deactivating the option in the content-editing tool;
presenting, responsive to an invocation input in the content-creation interface, the content editing tool within the content-creation interface, wherein the content editing tool, as presented, lacks the one or more deactivated options.

F19. The method of F4, further comprising:
presenting the branded design content in the content-creation interface;
receiving, via the content-creation interface, a user input specifying a first modification to the branded design content design;
determining that the first modification causes a violation of constraint from the brand profile;
identifying a second modification to the branded design content that resolves the violation; and
updating the content-creation interface to include the branded design content with the first modification and the second modification.

F20. The method of F4, further comprising:
presenting the branded design content in the content-creation interface;
receiving, via the content-creation interface, a user input specifying a modification to the branded design content design;
determining that the modification causes a violation of constraint from the brand profile; and
rejecting the modification to the branded design content that causes the violation.

F21. A method in which one or more processing devices perform operations comprising:
providing, to a user device, a profile-development interface;
identifying, based on input received via the profile-development interface, values for brand attributes that constrain creation of branded design content, the brand attributes comprising:
   (i) a font attribute indicating permissible text features for displaying text in branded design content,
   (ii) a color attribute indicating permissible colors for inclusion in the branded design content,
   (iii) a graphical attribute indicating permissible graphical content for inclusion in the branded design content, and
   (iv) a personality attribute indicating stylization options for the branded design content;
updating a brand profile to include the identified values for the brand attributes;
modifying a profile repository stored in a non-transitory computer-readable medium to include the brand profile having the identified values for the brand attributes; and
controlling a process for creating the branded design content by restricting permissible modifications to the branded design content that may be implemented via a content-creation interface provided to the user device.

F22. The method of F21, wherein restricting permissible modifications to the branded design content that may be implemented via the content-creation interface provided to the user device comprises:
receiving, via the content-creation interface, an edit input identifying a modification to the branded design content;
determining that the modification violates a constraint on one or more of (i) permissible text features specified by the font attribute and (ii) permissible visual features specified by one or more of the color attribute and the graphical attribute; and
rejecting the modification specified by the edit input based on determining that the modification violates the constraint.

F23. The method of F21, wherein restricting permissible modifications to the branded design content that may be implemented via the content-creation interface provided to the user device comprises:
receiving, via the content-creation interface, input comprising an input graphic, an input text element, and a selection of a command to create the branded design content; and
responsive to receiving the selection of the command to create the branded design content:
selecting a set of permissible text features that excludes text features that are (i) absent from the brand profile or (ii) identified in the brand profile as being impermissible,
selecting a set of permissible visual features that excludes visual features that are (i) absent from the brand profile or (ii) identified in the brand profile as being impermissible, and
creating the branded design content from the input graphic, the input text element, the set of permissible text features, and the set of permissible visual features.

F24. The method of F21, wherein identifying the values of the brand attributes comprises:
identifying, from the input received via the profile-development interface, a brand exemplar having a design content example with a text example and a graphic example;
performing an analysis of the brand exemplar that identifies (i) a set of font values for the font attribute included within the brand exemplar and (ii) a set of color values for the color attribute included within the brand exemplar;
updating the profile-development interface to include one or more control elements configured for receiving (i) font-selection input selecting at least some font values from the set of font values and (ii) color-selection input selecting at least some color values from the set of color values;
receiving the font-selection input and the color-selection input via the updated profile-development interface;
modifying the font attribute of the brand profile to include the at least some font values indicated by the font-selection input; and
modifying the color attribute of the brand profile to include the at least some color values indicated by the color-selection input.

F25. The method of F24, wherein updating the profile-development interface comprises:
determining that one or more of a font value and a color value has a frequency of occurrence within the brand exemplar that is less than a threshold frequency; and
excluding the one or more of the font value and the color value from the profile-development interface based on the frequency of occurrence within the brand exemplar being less than the threshold frequency.

F26. The method of F24, wherein updating the profile-development interface comprises displaying one or more font value indicators indicating all font values in the set of font values and displaying one or more color value indicators indicating all color values in the set of color values, wherein the operations further comprise:
receiving, via the updated profile-development interface, input indicating one or more of (i) a subset of font values from the set of font values and (ii) a subset of color values from the set of color values; and
excluding, from the brand profile, font or color values that are absent from the one or more of (i) the subset of font values and (ii) the subset of color values.

F27. The method of F21, wherein identifying the values of the brand attributes comprises:
accessing a first personality dimension dataset comprising stylization options corresponding to a first personality dimension;
accessing a second personality dimension dataset comprising stylization options corresponding to a second personality dimension;
determining, based on the input, a set of stylization options that (i) includes a first stylization option common to the first personality dimension dataset and the second personality dimension dataset and (ii) excludes a second stylization option present in either the first personality dimension dataset or the second personality dimension dataset; and
updating the personality attribute to indicate the set of stylization options.

F28. The method of F27, wherein identifying the values of the brand attributes further comprises:
updating the profile-development interface to display sample design content having the first stylization option and the second stylization option;
receiving, via the updated profile-development interface, input indicating a negative reaction with respect to a portion of the sample design content having the second stylization option; and
excluding, based on the input indicating the negative reaction, the second stylization option from the set of stylization options.

F29. The method of F21, the operations further comprising:
presenting, in the profile-development interface, visualizations of a first color and a second color;
receiving an input to a control element of the profile-development interface, the input selecting the first color as a permissible color; and
updating, based on the input to the control element, the brand profile to identify the first color as the permissible color, wherein controlling the process for creating the branded design content comprises one or more of (i) permitting the first color to be added to a text element or a graphical element and (ii) preventing the second color from being added to the text element or the graphical element.

F30. The method of F21, the operations further comprising:
presenting, in the profile-development interface, visualizations of a first color and a second color;
receiving an input to a control element of the profile-development interface, the input selecting the first color as a text color; and
updating, based on the input to the control element, the brand profile to identify the first color as a permissible text color, wherein controlling the process for creating the branded design content comprises one or more of (i) permitting text in the branded design content to have the first color and (ii) preventing the text in the branded design content from having the second color.

F31. The method of F29, the operations further comprising:
extracting the first color and the second color from an electronic brand exemplar based on a visual analysis of the brand exemplar; and
updating the profile-development interface to include the visualizations of the first color and the second color.

F32. The method of F21, further comprising:
extracting text from an electronic brand exemplar based on an analysis of the brand exemplar;
presenting, in the profile-development interface, font attribute values that are applied, in the electronic brand exemplar, to the extracted text; and
adding, responsive to user input via the profile-development interface, the font attribute values to the brand profile.

F33. The method of F21, further comprising:
extracting a text element from an electronic brand exemplar based on an analysis of the brand exemplar; and
presenting, in the profile-development interface, the text element;
adding, responsive to user input via the profile-development interface, the text element to the brand profile as a candidate text element; and
in the process for creating the branded design content:
presenting, in the content-creation interface, the candidate text element from the brand profile,
receiving, via the content-creation interface, user input selecting the candidate text element, and
creating the branded design content from the candidate text element selected from the content-creation interface.

F34. The method of F21, further comprising:
presenting, in the profile-development interface, a tool for modifying a cropping of a logo element; and
updating, based on input to the tool, the brand profile to include a logo variant having a modified cropping performed with the tool.

F35. The method of F21, further comprising:
presenting, in the profile-development interface, a tool for modifying a color used to display a logo element; and
updating, based on input to the tool, the brand profile to include a logo variant having a modified color specified with the tool.

F36. The method of F21, further comprising:
presenting, in the profile-development interface, a tool for modifying a permissible color for display adjacent to a logo element; and
updating, based on input to the tool, a logo attribute of the brand profile to identify the modified color specified with the tool.

F37. The method of F21, further comprising:
presenting, in the profile-development interface, a tool for modifying a prohibited color for display adjacent to a logo element; and
updating, based on input to the tool, a logo attribute of the brand profile to prevent a modified color specified with the tool from being displayed adjacent to the logo element.

F38. The method of any of features F34-F37, further comprising extracting the logo element from an electronic brand exemplar based on an analysis of the electronic brand exemplar.

F39. The method of F21, further comprising:
accessing a first personality dimension having a first value corresponding to a first set of stylization options, a second value corresponding to a second set of stylization options, and an intermediate value corresponding to a subset of the first and second sets of stylization options;
presenting, in the profile-development interface, a control element for selecting among the first value, the second value, and the intermediate value;
receiving, in the profile-development interface, an input to the control element that selects one of the first value, the second value, or the intermediate value;
determining a particular set of stylization options corresponding to the one of the first value, the second value, or the intermediate value selected via the control element; and
updating the personality attribute in the brand profile to include particular set of stylization options.

F40. The method of F39, further comprising:
accessing a third personality dimension having a third value corresponding to a third set of stylization options, a fourth value corresponding to a fourth set of stylization options, and an additional intermediate value corresponding to a subset of the third and fourth sets of stylization options;
presenting, in the profile-development interface, a control element for selecting among the third value, the fourth value, and the additional intermediate value;
receiving, in the profile-development interface, an input to the control element that selects one of the third value, the fourth value, or the additional intermediate value;
determining an additional particular set of stylization options corresponding to the one of the third value, the fourth value, or the additional intermediate value selected via the control element; and
updating the personality attribute in the brand profile to include (i) a first stylization option that is included in both the particular set of stylization options and the additional particular set of stylization options and (ii) a second stylization option that is included in either the particular set of stylization options or the additional particular set of stylization options.

F41. The method of F40, further comprising:
presenting a preview design that has been stylized using the first stylization option and the second stylization option;
receiving, via the profile-development interface, input indicating a negative reaction to a characteristic of the preview design; and
updating the brand profile to remove one or more of the first stylization option and the second stylization option, wherein the brand profile is updated based on the one or more of the first stylization option and the second stylization option causing the preview design to have the characteristic associated with the negative reaction.

General Considerations

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Aspects of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

1. A digital graphic design computing system comprising:
a network interface device configured for establishing one or more communications sessions with a user device via one or more data networks;
a non-transitory computer-readable medium storing a profile repository having brand profiles for controlling digital design content creation; and
processing hardware that is communicatively coupled to the non-transitory computer-readable medium and the network interface device and that is configured for:
(i) creating a brand profile within the profile repository, wherein creating the brand profile comprises:
(a) providing a profile-development interface to the user device via the one or more communication sessions,
(b) identifying, based on input received via the profile-development interface, values for brand attributes that constrain creation of branded design content, the brand attributes comprising one or more of a font attribute, a color attribute indicating permissible colors for inclusion in the branded design content, a graphical attribute indicating permissible graphical content for inclusion in the branded design content, and a personality attribute indicating stylization options for the branded design content,
(c) updating the brand profile to include the identified values for the brand attributes, and
(d) modifying the profile repository in the non-transitory computer-readable medium to include the brand profile as updated with the identified values for the brand attributes,
(ii) generating the branded design content, wherein creating the branded design content comprises:
(a) providing a content-creation interface to the user device via the one or more communication sessions,
(b) obtaining, based on input received via the content-creation interface, an input graphic and an input text element;
(c) identifying, from the brand profile as stored in the profile repository, one or more of a permissible text feature for the input text element and a permissible visual feature for displaying the input graphic,
(d) applying the one or more of the permissible text features to the input text element and the permissible visual feature to the input graphic,
(e) creating the branded design content by positioning, within a layout, the input text element and the input graphic having the one or more of the permissible text feature and the permissible visual feature applied,
(f) updating the content-creation interface to display the branded design content, and
(g) causing the network interface device to provide the user device with access to the updated content-creation interface.

2. The digital graphic design computing system of claim 1, wherein the processing hardware is configured for identifying the values of the brand attributes by performing operations comprising:
identifying, from the input received via the profile-development interface, a brand exemplar having a design content example with a text example and a graphic example;
performing an analysis of the brand exemplar that identifies (i) a set of font values for the font attribute included within the brand exemplar and (ii) a set of color values for the color attribute included within the brand exemplar;
updating the profile-development interface to include one or more control elements configured for receiving (i) font-selection input selecting at least some font values from the set of font values and (ii) color-selection input selecting at least some color values from the set of color values;
receiving the font-selection input and the color-selection input via the updated profile-development interface;
modifying the font attribute of the brand profile to include the at least some font values indicated by the font-selection input; and
modifying the color attribute of the brand profile to include the at least some color values indicated by the color-selection input.

3. The digital graphic design computing system of claim 1, wherein the processing hardware is further configured for generating the branded design content by performing at least a first iteration in which initial branded design content is modified without updating the content-creation interface to display the initial branded design content and a second iteration in which the content-creation interface is updated to display the branded design content,
wherein the first iteration comprises:
identifying, from the brand profile, an initial permissible text feature for the input text element and an initial permissible visual feature for displaying the input graphic,
retrieving an initial layout for the branded design content,
applying the initial permissible text feature to the input text element and positioning the input text element, with the initial permissible text feature, within the initial layout,
applying the initial permissible visual feature to the input graphic and positioning the input graphic, with the initial permissible visual feature, within the initial layout,
applying a design-quality model to the initial branded design content, wherein the initial branded design content has both (i) the input text element with the initial permissible text feature and (ii) the input graphic with the initial permissible visual feature positioned within the initial layout, and
determining, by applying the design-quality model to the initial branded design content, that the initial branded design content should be modified,
wherein the second iteration comprises performing at least one of:
selecting a different layout instead of the initial layout,
selecting the permissible text feature instead of the initial permissible text feature, and
selecting the permissible visual feature instead of the initial permissible visual feature.

4. A method in which one or more processing devices perform operations comprising:
providing, to a user device, a content-creation interface having control elements for identifying one or more input graphics and one or more input text elements to be included in branded design content;
receiving, via the content-creation interface, input comprising an input text element, an input graphic, and a selection of a command to create the branded design content;
creating, responsive to receiving the selection of the command, the branded design content by executing a content creation process comprising:
accessing a brand profile from a non-transitory computer-readable medium storing a brand profile repository;
identifying, from the brand profile, a permissible text feature for the input text element and a permissible visual feature for displaying the input graphic,
retrieving a layout for the branded design content,
applying the permissible text feature to the input text element and positioning the input text element, with the applied permissible text feature, within the layout,
applying the permissible visual feature to the input graphic and positioning the input graphic, with the applied permissible visual feature, within the layout, and
outputting the branded design content having the layout in which (i) the input text element with the applied permissible text feature and (ii) the input graphic with the applied permissible visual feature are positioned; and
updating the content-creation interface to display the branded design content.

5. The method of claim 4, wherein applying the permissible visual feature comprises positioning the input graphic adjacent to a brand color specified in the brand profile.

6. The method of claim 5, wherein positioning the input graphic adjacent to the brand color specified in the brand profile comprises one or more of (i) inserting the brand color next to the input graphic in a common layer of the layout and (ii) inserting the brand color and the input graphic in different layers, respectively, of the layout.

7. The method of claim 4, wherein applying the permissible visual feature comprises restricting a modification of a font attribute of the input text element to a permissible font attribute value identified in the brand profile.

8. The method of claim 4, wherein the content creation process comprises:
a first iteration in which initial branded design content is modified without updating the content-creation interface to display the initial branded design content; and
a second iteration in which the branded design content is outputted and the content-creation interface is updated to display the branded design content.

9. The method of claim 8, wherein the first iteration comprises:
identifying, from the brand profile, an initial permissible text feature for the input text element and an initial permissible visual feature for displaying the input graphic,
retrieving an initial layout for the branded design content,
applying the initial permissible text feature to the input text element and positioning the input text element, with the initial permissible text feature, within the initial layout,
applying the initial permissible visual feature to the input graphic and positioning the input graphic, with the initial permissible visual feature, within the initial layout,
applying a design-quality model to the initial branded design content, wherein the initial branded design content has both (i) the input text element with the initial permissible text feature and (ii) the input graphic with the initial permissible visual feature positioned within the initial layout, and
determining, from the design-quality model, that the initial branded design content should be modified,
wherein the second iteration comprises performing at least one of:
selecting the layout instead of the initial layout,
selecting the permissible text feature instead of the initial permissible text feature, and
selecting the permissible visual feature instead of the initial permissible visual feature.

10. The method of claim 4, wherein the control elements comprise one or more of:
a text field configured for receiving typing input that specifies the input text element, and
an upload element configured for (i) receiving an input identifying a memory location in which a file containing the input text element is stored and (ii) instructing the one or more processing devices to retrieve the file from the memory location.

11. The method of claim 4, wherein the control elements comprise one or more of:
an upload element configured for (i) receiving a text input identifying a memory location in which a file containing the input text element is stored and (ii) instructing the one or more processing devices to retrieve the file from the memory location; and
a drag-and-drop field configuring for receiving a drag-and-drop input moving a visual representation of the input graphic over the content-creation interface, wherein the one or more processing devices retrieve the input graphic responsive to receiving the drag-and-drop input.

12. The method of claim 4, the operations further comprising:
receiving, via the updated content-creation interface, an edit input identifying a modification to the branded design content;
determining that the modification violates one or more of (i) a constraint on permissible text features specified by the brand profile and (ii) a constraint on permissible visual features specified by the brand profile; and
rejecting the modification specified by the edit input.

13. A method in which one or more processing devices perform operations comprising:
providing, to a user device, a profile-development interface;
identifying, based on input received via the profile-development interface, values for brand attributes that constrain creation of branded design content, the brand attributes comprising:
(i) a font attribute indicating permissible text features for displaying text in branded design content,
(ii) a color attribute indicating permissible colors for inclusion in the branded design content,
(iii) a graphical attribute indicating permissible graphical content for inclusion in the branded design content, and
(iv) a personality attribute indicating stylization options for the branded design content;
updating a brand profile to include the identified values for the brand attributes;
modifying a profile repository stored in a non-transitory computer-readable medium to include the brand profile having the identified values for the brand attributes; and
controlling a process for creating the branded design content by restricting permissible modifications to the branded design content that may be implemented via a content-creation interface provided to the user device.

14. The method of claim 13, wherein restricting permissible modifications to the branded design content that may be implemented via a content-creation interface provided to the user device comprises:
receiving, via the content-creation interface, an edit input identifying a modification to the branded design content;
determining that the modification violates a constraint on one or more of (i) permissible text features specified by the font attribute and (ii) permissible visual features specified by one or more of the color attribute and the graphical attribute; and
rejecting the modification specified by the edit input based on determining that the modification violates the constraint.

15. The method of claim 13, wherein restricting permissible modifications to the branded design content that may be implemented via a content-creation interface provided to the user device comprises:
receiving, via the content-creation interface, input comprising an input graphic, an input text element, and a selection of a command to create the branded design content; and
responsive to receiving the selection of the command to create the branded design content:
selecting a set of permissible text features that excludes text features that are (i) absent from the brand profile or (ii) identified in the brand profile as being impermissible,
selecting a set of permissible visual features that excludes visual features that are (i) absent from the brand profile or (ii) identified in the brand profile as being impermissible, and
creating the branded design content from the input graphic, the input text element, the set of permissible text features, and the set of permissible visual features.

16. The method of claim 13, wherein identifying the values of the brand attributes comprises:
identifying, from the input received via the profile-development interface, a brand exemplar having a design content example with a text example and a graphic example;
performing an analysis of the brand exemplar that identifies (i) a set of font values for the font attribute included within the brand exemplar and (ii) a set of color values for the color attribute included within the brand exemplar;
updating the profile-development interface to include one or more control elements configured for receiving (i) font-selection input selecting at least some font values from the set of font values and (ii) color-selection input selecting at least some color values from the set of color values;
receiving the font-selection input and the color-selection input via the updated profile-development interface;
modifying the font attribute of the brand profile to include the at least some font values indicated by the font-selection input; and
modifying the color attribute of the brand profile to include the at least some color values indicated by the color-selection input.

17. The method of claim 16, wherein updating the profile-development interface comprises:
determining that one or more of a font value and a color value has a frequency of occurrence within the brand exemplar that is less than a threshold frequency; and
excluding the one or more of the font value and the color value from the profile-development interface based on the frequency of occurrence within the brand exemplar being less than the threshold frequency.

18. The method of claim 16, wherein updating the profile-development interface comprises displaying one or more font value indicators indicating all font values in the set of font values and displaying one or more color value indicators indicating all color values in the set of color values, wherein the operations further comprise:
receiving, via the updated profile-development interface, input indicating one or more of (i) a subset of font values from the set of font values and (ii) a subset of color values from the set of color values; and
excluding, from the brand profile, font or color values that are absent from the one or more of (i) the subset of font values and (ii) the subset of color values.

19. The method of claim 13, wherein identifying the values of the brand attributes comprises:
accessing a first personality dimension dataset comprising stylization options corresponding to a first personality dimension;
accessing a second personality dimension dataset comprising stylization options corresponding to a second personality dimension;
determining, based on the input, a set of stylization options that (i) includes a first stylization option common to the first personality dimension dataset and the second personality dimension dataset and (ii) excludes a second stylization option present in either the first personality dimension dataset or the second personality dimension dataset; and
updating the personality attribute to indicate the set of stylization options.

20. The method of claim 19, wherein identifying the values of the brand attributes further comprises:
updating the profile-development interface to display sample design content having the first stylization option and the second stylization option;
receiving, via the updated profile-development interface, input indicating a negative reaction with respect to a portion of the sample design content having the second stylization option; and
excluding, based on the input indicating the negative reaction, the second stylization option from the set of stylization options.
